(19) United States
(12) Patent Application Publication
(10) Pub. No.: US 2026/0219144 A1
(43) Pub. Date: Jul. 30, 2026

(54) FLASH-FILTRATION APPARATUS AND EXPERIMENTAL PLATFORM

(71) Applicant: SHENZHEN JINGTAI TECHNOLOGY CO., LTD., Shenzhen (CN)

(72) Inventors: Yang LIU, Shenzhen (CN); Yushan LIU, Shenzhen (CN); Shiyuan HE, Shenzhen (CN); Ruibin MAI, Shenzhen (CN)

(21) Appl. No.: 19/437,735

(22) Filed: Dec. 31, 2025

Related U.S. Application Data
(63) Continuation of application No. PCT/CN2025/103621, filed on Jun. 25, 2025.

(30) Foreign Application Priority Data
Jan. 27, 2025 (CN) 202510126693.7

(51) Int. Cl. G01N 1/34; B01D 25/12

(52) U.S. Cl. CPC G01N 1/34; B01D 25/12; B01D 2201/0415; B01D 2201/202

(57) ABSTRACT

A flash-filtration apparatus and an experimental platform are provided. The flash-filtration apparatus includes a support assembly, a filtration-press assembly, and a first clamping assembly. The filtration-press assembly includes a filtration-press plate. The filtration-press plate is slidably connected to the support assembly and movable in a first direction. The first clamping assembly includes a first tube-clamping mechanism. The first tube-clamping mechanism is slidably connected to the support assembly and movable in a second direction. The second direction intersects the first direction. The first tube-clamping mechanism is configured to clamp and move a flash-filtration-bottle inner tube, and place part of the flash-filtration-bottle inner tube into a flash-filtration-bottle outer tube. The filtration-press plate is configured to press the flash-filtration-bottle inner tube into the flash-filtration-bottle outer tube.

### CROSS-REFERENCE TO RELATED APPLICATION(S)

This application is a continuation of International Application No. PCT/CN2025/103621, filed Jun. 25, 2025, which claims priority to Chinese Patent Application No. 202510126693.7, filed Jan. 27, 2025, the entire disclosure of which are incorporated herein by reference.

### TECHNICAL FIELD

This disclosure relates to the field of automation equipment technology, and in particular, to a flash-filtration apparatus and an experimental platform.

### BACKGROUND

In chemical experiments, reacted samples often need to be filtered, and then clarified liquid obtained by filtration is subjected to subsequent operations such as analysis and detection. In the related art, generally, an experimenter manually aspirates mother liquor with a piston-type syringe, then attaches a filter tip to an end of the syringe, and subsequently presses down a piston to filter the mother liquor through the filter tip.

### SUMMARY

In a first aspect, the present disclosure provides a flash-filtration apparatus. The flash-filtration apparatus includes a support assembly, a filtration-press assembly, and a first clamping assembly. The filtration-press assembly includes a filtration-press plate. The filtration-press plate is slidably connected to the support assembly and movable in a first direction. The first clamping assembly includes a first tube-clamping mechanism. The first tube-clamping mechanism is slidably connected to the support assembly and movable in a second direction. The second direction intersects the first direction. The first tube-clamping mechanism is configured to clamp and move a flash-filtration-bottle inner tube, and place part of the flash-filtration-bottle inner tube into a flash-filtration-bottle outer tube. The filtration-press plate is configured to press the flash-filtration-bottle inner tube into the flash-filtration-bottle outer tube.

In a second aspect, the present disclosure further provides an experimental platform. The experimental platform includes a base and the flash-filtration apparatus in the first aspect. The support assembly of the flash-filtration apparatus is mounted on the base.

### BRIEF DESCRIPTION OF THE DRAWINGS

To more clearly describe implementations in the present disclosure or technical solutions in related art, the accompanying drawings that need to be used in description of implementations or the related art will be briefly introduced below. Apparently, the accompanying drawings in the following description are only some implementations in the present disclosure, and those of ordinary skill in the art may also obtain other accompanying drawings based on these accompanying drawings without creative effort.

FIG. 1 is a perspective view of a flash-filtration apparatus according to an embodiment.

FIG. 2 is a perspective view of a flash-filtration apparatus according to an embodiment from another angle.

FIG. 3 is a front view of a flash-filtration apparatus according to an embodiment.

FIG. 4 is a perspective view of a first tube-clamping mechanism according to an embodiment.

FIG. 5 is a perspective view of a flash-filtration-bottle transfer assembly according to an embodiment.

FIG. 6 is a perspective view of an experimental platform according to an embodiment.

FIG. 7 is a perspective view of an experimental platform according to an embodiment from another angle.

FIG. 8 is a perspective view of a sampling apparatus according to an embodiment.

FIG. 9 is a perspective view of a pipetting assembly according to an embodiment.

FIG. 10 is a front view of a pipetting assembly according to an embodiment.

FIG. 11 is a perspective view of a second tube-clamping mechanism according to an embodiment.

FIG. 12 is a front view of a second tube-clamping mechanism according to an embodiment.

FIG. 13 is a perspective view of a pipette-tip tray assembly according to an embodiment.

FIG. 14 is a perspective view of a test-tube rack assembly according to an embodiment.

FIG. 15 is a front view of a third clamping assembly according to an embodiment.

FIG. 16 is a cross-sectional view of a third clamping assembly according to an embodiment.

FIG. 17 is a perspective view of a flash-filtration apparatus according to another embodiment.

FIG. 18 is a perspective view of a flash-filtration apparatus according to yet another embodiment.

Description of reference signs of the accompanying drawings:
1000—experimental platform, 100—flash-filtration apparatus, 10—support assembly, 11—support post, 12—movable plate, 212—first slide rail, 13—top plate, 14—first lifting mechanism, 141—first lifting driving member, 142—first transmission rod, 143—first floating joint, 144—second floating joint, 145—pressure sensor, 15—side plate, 151—second slide rail, 16—support frame, 161—first plate, 162—second plate, 163—first guide rail, 20—filtration-press assembly, 21—filtration-press plate, 22—first translation mechanism, 221—first translation driving member, 222—first transmission portion, 23—first sliding table, 24—second guide rail, 30 first clamping assembly, 31—first tube-clamping mechanism, 311—first clamping driving member, 312—first clamping portion, 3121—first mounting plate, 3122—first finger, 313—second clamping portion, 3131—second mounting plate, 3132—second finger, 314—first transmission member, 32—guide shaft, 33—second sliding table, 34—second lifting mechanism, 341—second lifting driving member, 342—second transmission rod, 40—liquid-dispensing assembly, 41—liquid-dispensing needle, 42—liquid-dispensing pump, 43—liquid-dispensing-needle mounting seat, 44—cleaning mechanism, 441—cleaning tank, 442—cleaning pump, 443—cleaning-tank mounting frame, 50—flash-filtration-bottle transfer assembly, 51—flash-filtration-bottle tray placement seat, 511—first tray-placement-seat, 512—second tray-placement-seat, 513—connection plate, 52—first moving mechanism, 521—first moving driving member, 522—second transmission portion, 53—mounting base, 531—sliding guide rail, 54—baffle plate, 541—through hole, 200—base, 300—sampling apparatus, 301—second translation mechanism, 302—third sliding table, 303—second translation driving member, 304—third transmission portion, 60—pipetting assembly, 61—pipette-tip mounting seat, 62—pipetting pump, 63—fourth sliding table, 64—third lifting mechanism, 641—third lifting driving member, 65—first mounting platform, 651—mounting back plate, 652—first horizontal rail, 653—vertical rail, 66—spacing-adjusting mechanism, 661—spacing-adjusting driving member, 662—spacing-adjusting plate, 663—spacing-adjusting transmission member, 67—pressing plate, 68—pressing mechanism, 681—pressing driving member, 682—pressing transmission member, 683—sensing element, 684—second horizontal rail, 69—separating member, 691—spring-buffer structure, 70—second clamping assembly, 71—second mounting platform, 72—fourth lifting mechanism, 721—fourth lifting driving member, 73—second tube-clamping mechanism, 731—second clamping driving member, 732—third clamping portion, 7321—third mounting plate, 7322—third finger, 7323—mounting shaft, 7324—limit ring, 7325—pre-tightening spring, 733—fourth clamping portion, 7331—fourth mounting plate, 7332—fourth finger, 734—first fixed plate, 735—second fixed plate, 736—slider, 737—finger mounting member, 738—third transmission member, 739—fourth transmission member, 74—buffering mechanism, 75—third mounting platform, 80—pipette-tip tray assembly, 81—pipette-tip tray placement seat, 821—second moving driving member, 822—fourth transmission portion, 83—fixed seat, 84—pipette-tip mounting frame, 841—avoidance space, 90—test-tube rack assembly, 91—test-tube rack placement seat, 92—test-tube mounting frame, 921—magnet mounting plate, 922—magnet, 93—third clamping assembly, 931—third tube-clamping mechanism, 9311—third clamping driving member, 9312—finger mounting seat, 9313—fifth finger, 9314—electrical slip ring, 932—rotary driving member, 933—first gear, 934—second gear, 935—third gear, 94—gripper support frame, 2001—flash-filtration-bottle inner tube, 2002—flash-filtration-bottle outer tube, 2003—pipette tip, 2004—test tube, Z—first direction, X—second direction, Y—third direction, L1—first axis.

### DETAILED DESCRIPTION

The following will illustrate clearly technical solutions of implementations of the present disclosure with reference to accompanying drawings of implementations of the present disclosure. The implementations illustrated herein are merely some, rather than all implementations, of the present disclosure. Based on the implementations of the present disclosure, other implementations obtained by those of ordinary skill in the art shall fall within the protection scope of the present disclosure.

It is to be noted that, when a component (element or member) is deemed as being “fixed” or “secured” to another component (element or member), the component (element or member) can be directly on the other component (element or member) or there may be an intermediate component (element or member) between the two components (elements or members). When a component (element or member) is considered to be “connected” or “coupled” to another component (element or member), the component (element or member) may be directly connected or coupled to the other component (element or member) or there may be an intermediate component (element or member) between the two components (elements or members).

Unless otherwise defined, all technical and scientific terms used herein have the same meaning as commonly understood by those skilled in the art of the present disclosure. The terms used herein in the present disclosure are for the purpose of describing specific embodiments only and are not intended to limit the present disclosure. The term “and/or” used herein includes any and all combinations of one or more related listed items. The term “at least one of A or B” used herein refers to A alone, B alone, or both A and B.

In chemical experiments, reacted samples often need to be filtered, and then clarified liquid obtained by filtration is subjected to subsequent operations such as analysis and detection. In the related art, generally, an experimenter manually aspirates mother liquor with a piston-type syringe, then attaches a filter tip to an end of the syringe, and subsequently presses down a piston to filter the mother liquor through the filter tip. The above manual operation process is cumbersome and inefficient, requiring a large amount of manpower to perform repetitive work. In addition, the manual operation of experimenters is likely to contaminate the experimental samples and easily cause experimental errors. Moreover, some harmful experimental samples may also adversely affect the health of experimenters.

The purpose of the present disclosure is to provide a flash-filtration apparatus and an experimental platform to solve the problems of low efficiency, large experimental errors, and low safety in manual experiments. In order to achieve the purpose of the present disclosure, the present disclosure provides the following technical solutions.

Hereinafter, some implementations of the present disclosure will be described in detail with reference to the accompanying drawings. In the case of no conflict, the following embodiments and the features in the embodiments can be combined with each other.

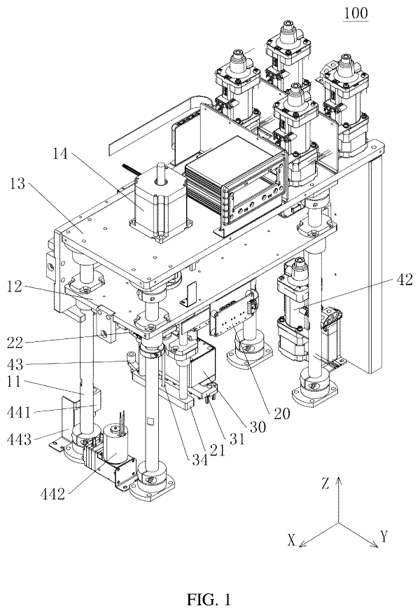

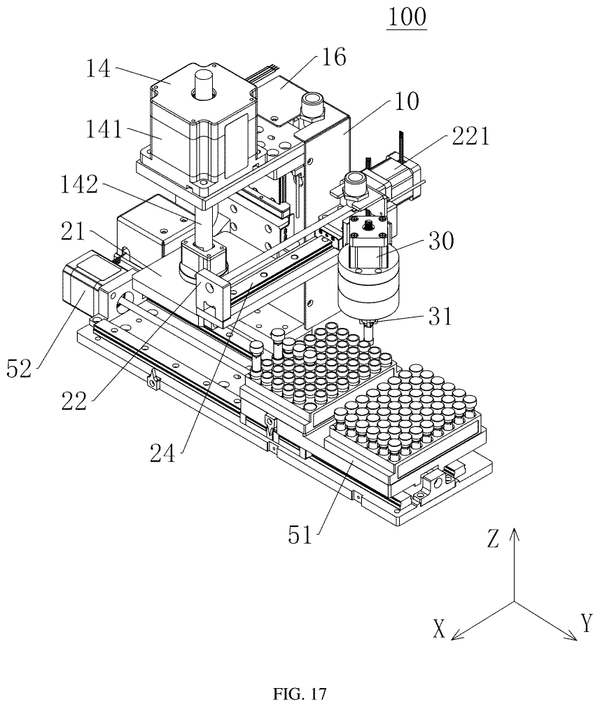

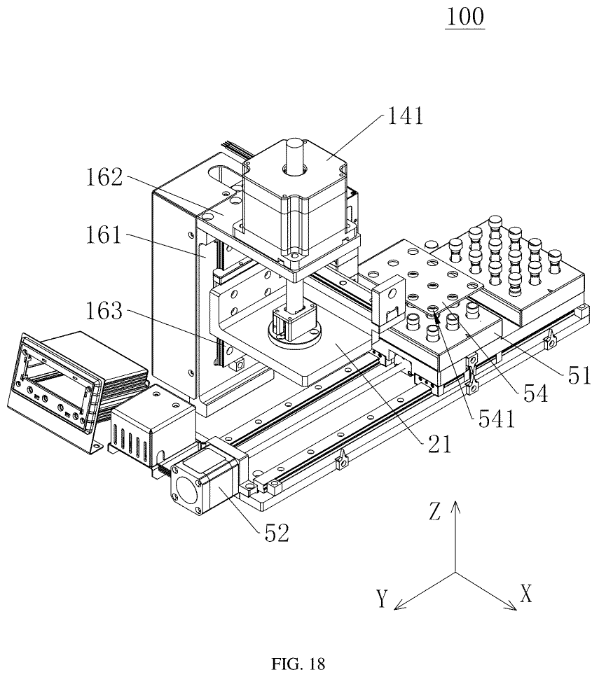

Reference can be made to FIG. 1 to FIG. 7, FIG. 17, and FIG. 18. A flash-filtration apparatus 100 is provided in embodiments of the present disclosure. The flash-filtration apparatus 100 includes a support assembly 10, a filtration-press assembly 20, and a first clamping assembly 30.

First, directions are defined. Referring to FIG. 1, Z is a first direction, X is a second direction, and Y is a third direction. The first direction Z, the second direction X, and the third direction Y intersect in pairs. Optionally, the first direction Z, the second direction X, and the third direction Y are perpendicular to one another in pairs.

The filtration-press assembly 20 includes a filtration-press plate 21. The filtration-press plate 21 is slidably connected to the support assembly 10 and movable in the first direction Z. The first clamping assembly 30 includes a first tube-clamping mechanism 31. The first tube-clamping mechanism 31 is slidably connected to the support assembly 10 and movable in the second direction X.

The support assembly 10 may be made of materials with high structural strength, specifically may be a metal material, high-strength plastic, ceramic, etc. The metal material may be, for example, aluminum, aluminum alloy, magnesium alloy, iron or iron alloy, etc.

In an embodiment, as illustrated in FIG. 1 to FIG. 7, the support assembly 10 includes a support post 11 and a movable plate 12. The support post 11 extends in the first direction Z. The movable plate 12 is slidably connected to the support post 11 and movable in the first direction Z. The filtration-press plate 21 is slidably connected to the movable plate 12 and movable in the second direction X. The first tube-clamping mechanism 31 is slidably connected to the movable plate 12 and movable in the second direction X. The first tube-clamping mechanism 31 is also movable relative to the filtration-press plate 21 in the first direction Z.

Optionally, the filtration-press plate 21 and/or the first tube-clamping mechanism 31 is also movable in the third direction Y, so that the movable range is expanded and flexibility is improved. Exemplarily, in addition to moving in the second direction X together with the filtration-press plate 21, the first tube-clamping mechanism 31 is also movable relative to the filtration-press plate 21 in the third direction Y. Alternatively, in addition to moving in the second direction X together with the first tube-clamping mechanism 31, the filtration-press plate 21 is also movable relative to the first tube-clamping mechanism 31 in the third direction Y.

There may be one support post 11 or multiple support posts 11, which is not limited. Optionally, there are multiple support posts 11, and the multiple support posts 11 are arranged at intervals. The movable plate 12 is slidably connected to all the multiple support posts 11. As illustrated in FIG. 1, the movable plate 12 is a square plate, and there are four support posts 11 respectively located at four top corners of the movable plate 12, so that not only can the movable plate 12 be stably supported, but also other components above and below the movable plate 12 can be avoided to prevent interference. The support post 11 may be columnar, plate-shaped, rod-shaped, etc., which is not limited. The movable plate 12 and the support post 11 may be slidably connected by at least one means such as a linear bearing, a slide rail, etc.

The filtration-press plate 21 and the movable plate 12 may be directly connected or indirectly connected, which is not specifically limited. Optionally, the filtration-press plate 21 is also movable relative to the movable plate 12 in the first direction Z, or the filtration-press plate 21 is synchronously movable with the movable plate 12 in the first direction Z.

Optionally, the first tube-clamping mechanism 31 and the filtration-press plate 21 can move synchronously in the second direction X. Alternatively, the first tube-clamping mechanism 31 and the filtration-press plate 21 can move independently of each other in the second direction X, without limitation. Optionally, the first direction Z is a height direction of the flash-filtration apparatus 100, and the second direction X is a horizontal direction of the flash-filtration apparatus 100. For example, the second direction X is a length direction of the movable plate 12, or an arrangement direction of the filtration-press assembly 20 and the first clamping assembly 30 (such as a front-back direction or a left-right direction). At this time, the filtration-press plate 21 may be spaced apart from the first tube-clamping mechanism 31 in the second direction X or in the third direction Y. Optionally, the first direction Z is the horizontal direction of the flash-filtration apparatus 100, and the second direction X is the height direction of the flash-filtration apparatus 100, without limitation. At this time, the filtration-press plate 21 may be spaced apart from the first tube-clamping mechanism 31 in the first direction Z or in the third direction Y.

The flash-filtration apparatus 100 is configured to filter sample liquid in a flash-filtration bottle. The flash-filtration bottle may be configured for rapid filtration of chromatographic injection solvent. The flash-filtration bottle includes a flash-filtration-bottle inner tube and a flash-filtration-bottle outer tube. The flash-filtration-bottle inner tube is nestable in the flash-filtration-bottle outer tube.

Specifically, a filtration-press membrane is provided at the bottom of the flash-filtration-bottle inner tube. The bottom of the flash-filtration-bottle outer tube is sealed, and the flash-filtration-bottle outer tube is used to contain the liquid to-be-filtered. When the flash-filtration-bottle inner tube is pressed into the flash-filtration-bottle outer tube, the liquid to-be-filtered enters the flash-filtration-bottle inner tube through the filtration-press membrane. The flash-filtration bottle may have the common structure on the market, without limitation here.

Optionally, the liquid to-be-filtered includes sample liquid, or the liquid to-be-filtered includes sample liquid and diluent. The sample liquid is typically a raw liquid sample obtained from an organism or environment, which contains substances or information to-be-detected. The diluent is typically water or another inert solvent, which is used to dilute thick sample liquid to an appropriate concentration range for more accurate analysis.

The first tube-clamping mechanism 31 is configured to clamp and move the flash-filtration-bottle inner tube 2001, and place part of the flash-filtration-bottle inner tube 2001 into the flash-filtration-bottle outer tube 2002. The filtration-press plate 21 is configured to press the flash-filtration-bottle inner tube 2001 into the flash-filtration-bottle outer tube 2002.

Optionally, the first tube-clamping mechanism 31 may operate on only a single flash-filtration-bottle inner tube 2001, or may clamp and move multiple flash-filtration-bottle inner tubes 2001 simultaneously, without specific limitation. Similarly, during the movement of the filtration-press plate 21 in the first direction Z, the filtration-press plate 21 may press only one flash-filtration-bottle inner tube 2001 into the flash-filtration-bottle outer tube 2002, or may press multiple flash-filtration-bottle inner tubes 2001 into the flash-filtration-bottle outer tube 2002 simultaneously, without limitation.

Specifically, the flash-filtration-bottle inner tube 2001 is spaced apart from the flash-filtration-bottle outer tube 2002. The liquid to-be-filtered is contained in the flash-filtration-bottle outer tube 2002. The first tube-clamping mechanism 31 can clamp the flash-filtration-bottle inner tube 2001 and move the flash-filtration-bottle inner tube 2001 in the second direction X to above the flash-filtration-bottle outer tube 2002. Then, the filtration-press plate 21 moves in the second direction X relative to the movable plate 12, so that the filtration-press plate 21 is located above the flash-filtration-bottle inner tube 2001 and the flash-filtration-bottle outer tube 2002, and is substantially aligned with one end of the flash-filtration-bottle inner tube 2001 away from a bottom wall of the flash-filtration-bottle outer tube 2002. Then, the movable plate 12 slides in the first direction Z relative to the support post 11 and drives the filtration-press plate 21 to move in the first direction Z towards the flash-filtration-bottle inner tube 2001 until the filtration-press plate 21 abuts against the flash-filtration-bottle inner tube 2001 and presses the flash-filtration-bottle inner tube 2001 into the flash-filtration-bottle outer tube 2002. At this time, the flash-filtration-bottle inner tube 2001 applies pressure to the flash-filtration-bottle outer tube 2002, so that the liquid to-be-filtered in the flash-filtration-bottle outer tube 2002 enters the flash-filtration-bottle inner tube 2001 through the filtration-press membrane at the bottom of the flash-filtration-bottle inner tube 2001, thereby completing filtration of the liquid to-be-filtered.

For the flash-filtration apparatus 100 in the embodiment of the present disclosure, the movable plate 12 is movable in the first direction Z relative to the support post 11, the first tube-clamping mechanism 31 is slidably connected to the movable plate 12, and the first tube-clamping mechanism 31 can clamp the flash-filtration-bottle inner tube 2001 and move the flash-filtration-bottle inner tube 2001 in the second direction X to above the flash-filtration-bottle outer tube 2002. In addition, the filtration-press plate 21 is slidably connected to the movable plate 12 and movable in the second direction X, and also movable in the first direction Z under the drive of the movable plate 12, thereby accurately pressing the flash-filtration-bottle inner tube 2001 into the flash-filtration-bottle outer tube 2002. Therefore, the flash-filtration apparatus 100 can complete the workflow without manual operation, thereby improving experimental efficiency, reducing potential contamination caused by manual operation, reducing experimental errors, improving experimental safety.

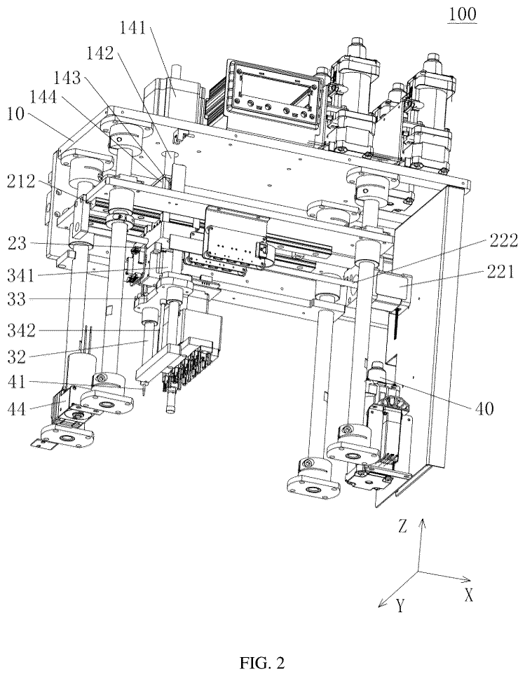

In an embodiment, as illustrated in FIG. 1 and FIG. 2, the support assembly 10 further includes a top plate 13 and a first lifting mechanism 14. The top plate 13 is fixedly connected to the support post 11. The first lifting mechanism 14 is disposed on the top plate 13 and connected to the movable plate 12. The first lifting mechanism 14 is configured to drive the movable plate 12 to move in the first direction Z.

The top plate 13 can improve the structural stability of the support assembly 10 and can be used for mounting of other components of the flash-filtration apparatus 100. Optionally, the top plate 13 is substantially rectangular and substantially parallel to the horizontal plane. The top plate 13 and the support post 11 may be of an integrated structure or a split structure. The top plate 13 and the support post 11 may be connected and fixed by means of welding, bonding, snapping, screwing, riveting, etc., without limitation. Optionally, the movable plate 12 is located between the top plate 13 and one end of the support post 11 away from the top plate 13.

Optionally, the first lifting mechanism 14 includes a first lifting driving member 141 and a first transmission rod 142. The first lifting driving member 141 is disposed on the top plate 13. The first transmission rod 142 is connected to the movable plate 12 and extends in the first direction Z. The first lifting driving member 141 is in transmission fit with the first transmission rod 142 and is configured to drive the first transmission rod 142 to move in the first direction Z or rotate around an axis of the first transmission rod 142.

Optionally, the first lifting driving member 141 may be a motor, an oil cylinder, an air cylinder, etc., without limitation. The first lifting driving member 141 may be configured to drive the first transmission rod 142 to move in an axial direction of the first transmission rod 142. The first lifting driving member 141 has a drive shaft, and the drive shaft can move linearly when the first lifting driving member 141 operates. For example, when the first lifting driving member 141 is a motor, the motor is a linear motor or a lead screw motor, so that the drive shaft of the first lifting driving member 141 can move linearly. For another example, when the first lifting driving member 141 is an oil cylinder or an air cylinder, the drive shaft is a piston rod, which can perform linear telescopic movement. Alternatively, the first lifting driving member 141 may also be used to drive the first transmission rod 142 to rotate around the axis of the first transmission rod 142, without limitation.

The connection manner between the first lifting driving member 141 and the top plate 13 may be welding, bonding, snapping, screwing, riveting, etc., without limitation.

In an embodiment, the first lifting driving member 141 is a motor, and the first transmission rod 142 is a lead screw. The first lifting driving member 141 is in transmission connection with the first transmission rod 142 (for example, a drive shaft of the motor is connected to the first transmission rod 142 through a coupling). Optionally, the first transmission rod 142 rotates around the axis of the first transmission rod 142 under the drive of the first lifting driving member 141 and is connected to the movable plate 12 through a nut. The first transmission rod 142 and the nut form a lead screw and nut pair, so that the rotational motion of the first transmission rod 142 can be converted into the linear motion of the movable plate 12, and the movable plate 12 can move relative to the support post 11 in the axial direction of the first transmission rod 142 (i.e., the first direction Z) under the transmission connection of the first transmission rod 142. Alternatively, optionally, the first lifting driving member 141 is in transmission connection with the first transmission rod 142 through a rack and pinion pair, so that the first transmission rod 142 can move relative to the support post 11 in the axis of the first transmission rod 142, thereby driving the movable plate 12 to move relative to the support post 11 in the first direction Z. Both of the above two transmission connection manners are acceptable, without specific limitation.

By providing the first lifting mechanism 14, the first lifting mechanism 14 can drive the movable plate 12 to move in the first direction Z, with high transmission efficiency. The transmission manner can be selected according to the actual product needs.

In an embodiment, as illustrated in FIG. 1 and FIG. 2, the filtration-press assembly 20 further includes a first translation mechanism 22 and a first sliding table 23. The first translation mechanism 22 is disposed on the movable plate 12. The first sliding table 23 is slidably connected to the movable plate 12 in the second direction X. The filtration-press plate 21 is connected to the first sliding table 23. The first translation mechanism 22 is connected to the first sliding table 23 and is configured to drive the first sliding table 23 to move in the second direction X.

The shape of the first sliding table 23 may be block-shaped, plate-shaped, columnar or other irregular shapes, etc., without limitation. The first sliding table 23 and the filtration-press plate 21 may be fixedly connected. Alternatively, the filtration-press plate 21 is also movable relative to the first sliding table 23 in the first direction Z.

Optionally, a first slide rail 212 is provided on a surface of the movable plate 12 facing away from the top plate 13. The first slide rail 212 extends in the second direction X. The first sliding table 23 is slidably connected to the first slide rail 212 and is configured to move relative to the first slide rail 212 in the second direction X under the drive of the first translation mechanism 22.

The first translation mechanism 22 may be any feasible driving transmission structure in the art. Optionally, the first translation mechanism 22 includes a first translation driving member 221. The first translation driving member 221 is disposed on the movable plate 12. Similar to the first lifting driving member 141, the first translation driving member 221 may be a motor, an oil cylinder, an air cylinder, etc., without limitation.

Optionally, the first translation driving member 221 may be a linear motor. The first translation mechanism 22 further includes a first transmission portion 222. The first transmission portion 222 includes a lead screw and nut pair (i.e., a lead screw and a nut provided on the lead screw, and the lead screw extends in the second direction X). The lead screw is connected to the drive shaft of the linear motor through a coupling. The nut is connected to the first sliding table 23. The linear motor is configured to drive the lead screw to rotate, so that the nut moves linearly on the lead screw, thereby driving the first sliding table 23 to move on the movable plate 12 along the first slide rail 212.

The filtration-press assembly 20 further includes the first translation mechanism 22 and the first sliding table 23, the filtration-press plate 21 is connected to the first sliding table 23, the first translation mechanism 22 is configured to drive the first sliding table 23 to move in the second direction X, so that the filtration-press plate 21 can move in the second direction X. Therefore, the filtration-press plate 21 can accurately move to the specified position and press the flash-filtration-bottle inner tube 2001 into the flash-filtration-bottle outer tube 2002, thereby facilitating the flexible operation of flash-filtration bottles at different positions and realizing high experimental accuracy.

In an embodiment, as illustrated in FIG. 1 and FIG. 2, the first clamping assembly 30 further includes a guide shaft 32, a second sliding table 33, and a second lifting mechanism 34. The guide shaft 32 extends in the first direction Z. One end of the guide shaft 32 is connected to the first sliding table 23, and the other end of the guide shaft 32 is connected to the filtration-press plate 21. The second sliding table 33 is slidably connected to the guide shaft 32. The first tube-clamping mechanism 31 is connected to the second sliding table 33. The second lifting mechanism 34 is disposed on the first sliding table 23 and is connected to the second sliding table 33. The second lifting mechanism 34 is configured to drive the second sliding table 33 to move in the first direction Z.

The number of the guide shafts 32 may be one or more, without limitation. In a specific embodiment, as illustrated in FIG. 2, there are two guide shafts 32 spaced apart from each other, which are respectively disposed at two opposite ends of the filtration-press plate 21 and can stably carry the second sliding table 33. Optionally, the guide shaft 32, the first sliding table 23, and the filtration-press plate 21 may be of an integrated structure. Alternatively, the fixed connection between the guide shaft 32 and the first sliding table 23 and the fixed connection between the guide shaft 32 and the filtration-press plate 21 may be established by means of welding, bonding, snapping, screwing, riveting, etc., without limitation. The guide shaft 32 serves as both a connection structure between the filtration-press plate 21 and the first sliding table 23 and a guiding structure for relative movement between the second sliding table 33 and the filtration-press plate 21, thereby realizing structure reuse, simplifying the structure arrangement, and realizing lightweight design. It can be understood that the guide shaft 32 may be replaced by a similar structure having equivalent functions. For example, the guide shaft 32 may be replaced by a connection plate and a slide rail provided on the connection plate, the connection plate is respectively connected to the first sliding table 23 and the filtration-press plate 21, and the second sliding table 33 is connected to the slide rail through a slider.

The shape of the second sliding table 33 may be block-shaped, plate-shaped, columnar, or other irregular shapes, etc., without limitation. Optionally, the second sliding table 33 is sleeved on the guide shaft 32 and may be slidably connected to the guide shaft 32 through a linear bearing. The connection manner between the first tube-clamping mechanism 31 and the second sliding table 33 may be welding, bonding, snapping, screwing, riveting, etc., without limitation.

The second lifting mechanism 34 may be any feasible driving and transmission structure in the art. Optionally, the second lifting mechanism 34 includes a second lifting driving member 341 and a second transmission rod 342. The second lifting driving member 341 is disposed on the first sliding table 23. The second transmission rod 342 extends in the first direction Z and is in transmission connection with the second lifting driving member 341. Similarly, the second lifting driving member 341 may be a motor, an oil cylinder, an air cylinder, etc., without limitation. The second lifting driving member 341 may be configured to drive the second transmission rod 342 to move in an axial direction of the second transmission rod 342. The second lifting driving member 341 has a drive shaft, and the drive shaft can move linearly when the second lifting driving member 341 operates.

The connection manner between the second lifting driving member 341 and the first sliding table 23 may be welding, bonding, snapping, screwing, riveting, etc., without limitation.

Optionally, the second transmission rod 342 rotates around an axis of the second transmission rod 342 under the drive of the second lifting driving member 341 and is connected to the second sliding table 33 through a nut. The second transmission rod 342 and the nut form a lead screw and nut pair, so that the rotational motion of the second transmission rod 342 can be converted into the linear motion of the second sliding table 33, and the second sliding table 33 can move relative to the filtration-press plate 21 in the axial direction of the second transmission rod 342 (i.e., the first direction Z) under the transmission connection of the second transmission rod 342.

The second lifting mechanism 34 can drive the second sliding table 33 to move in the first direction Z, thereby driving the first tube-clamping mechanism 31 to move relative to the filtration-press plate 21 in the first direction Z. Therefore, the movement of the first tube-clamping mechanism 31 is flexible, and the driving manner is simple and reliable. When the second lifting mechanism 34 is used to clamp the flash-filtration-bottle inner tube 2001, the second lifting mechanism 34 can drive the second sliding table 33 to move towards the flash-filtration-bottle inner tube 2001 in the first direction Z, so that the first tube-clamping mechanism 31 approaches and clamps the flash-filtration-bottle inner tube 2001. When the movable plate 12 moves in the first direction Z to drive the filtration-press plate 21 to press the flash-filtration-bottle inner tube 2001 into the flash-filtration-bottle outer tube 2002, the second lifting mechanism 34 can drive the first tube-clamping mechanism 31 to move in the first direction Z and away from the flash-filtration-bottle inner tube 2001, so as to avoid interference between the first tube-clamping mechanism 31 and the flash-filtration-bottle inner tube 2001.

The first clamping assembly 30 is disposed on the filtration-press assembly 20, so that the first clamping assembly 30 and the filtration-press assembly 20 can move synchronously in the first direction and move synchronously in the second direction, thereby simplifying the driving manner, improving the apparatus integration, and reducing the space occupation of the apparatus.

In another embodiment, reference can be made to FIG. 17 and FIG. 18. The support assembly 10 includes a support frame 16 and a first lifting mechanism 14 provided on the support frame 16. The first lifting mechanism 14 is connected to the filtration-press plate 21. The first lifting mechanism 14 is configured to drive the filtration-press plate 21 to move in the first direction Z.

The support frame 16 may be of an integrated structure or a split structure, without specific limitation. The first lifting mechanism 14 includes a first lifting driving member 141 and a first transmission rod 142. The first transmission rod 142 is connected to the filtration-press plate 21 and extends in the first direction Z.

Optionally, the transmission manner between the first lifting driving member 141 and the first transmission rod 142 can refer to the above and will not be repeated here.

Optionally, the support frame 16 includes a first plate 161 and a second plate 162. The second plate 162 is connected to one end of the first plate 161. A cross-section of the support frame 16 is substantially in an “L” shape. The first plate 161 extends in the first direction Z. The first lifting driving member 141 is disposed on the second plate 162. Optionally, the first plate 161 is provided with a first guide rail 163. The first guide rail 163 extends in the first direction Z. The filtration-press plate 21 is also slidably connected to the first guide rail 163, and is configured to move relative to the first guide rail 163 in the first direction Z under the drive of the first lifting mechanism 14.

By providing the first lifting mechanism 14, the first lifting mechanism 14 can drive the filtration-press plate 21 to move in the first direction Z, with high transmission efficiency. The transmission manner can be selected according to the actual product needs.

In an embodiment, as illustrated in FIG. 17 and FIG. 18, the first tube-clamping mechanism 31 is slidably connected to the filtration-press plate 21 and can move in the second direction X. The filtration-press assembly 20 further includes a first translation mechanism 22. The first translation mechanism 22 is arranged on the filtration-press plate 21. The first translation mechanism 22 is connected to the first tube-clamping mechanism 31 and is configured to drive the first tube-clamping mechanism 31 to move in the second direction X.

The connection between the first translation mechanism 22 and the filtration-press plate 21 may be direct or indirect, without limitation. When the first lifting mechanism 14 drives the filtration-press plate 21 to move in the first direction Z, the first tube-clamping mechanism 31 and the first translation mechanism 22 move synchronously with the filtration-press plate 21 in the first direction Z.

Optionally, the filtration-press plate 21 is provided with a second guide rail 24. The second guide rail 24 extends in the second direction X. The first tube-clamping mechanism 31 is also slidably connected to the second guide rail 24, and is configured to move relative to the second guide rail 24 in the second direction X under the drive of the first translation mechanism 22.

The structure of the first translation mechanism 22 is similar to the aforementioned one, so reference may be made thereto without further explanation.

The filtration-press assembly 20 further includes the first translation mechanism 22, and the first translation mechanism 22 is disposed on the filtration-press plate 21 and configured to drive the first tube-clamping mechanism 31 to move in the second direction X, so that the first tube-clamping mechanism 31 can move in the second direction X. Therefore, the first tube-clamping mechanism 31 can accurately move to the specified position and clamp the flash-filtration-bottle inner tube 2001 and/or the flash-filtration-bottle outer tube 2002, thereby facilitating the flexible operation of flash-filtration bottles at different positions and realizing high experimental accuracy.

Optionally, the first translation mechanism 22 is further configured to drive the first tube-clamping mechanism 31 to move in the third direction Y, so as to further expand the movable range of the first tube-clamping mechanism 31.

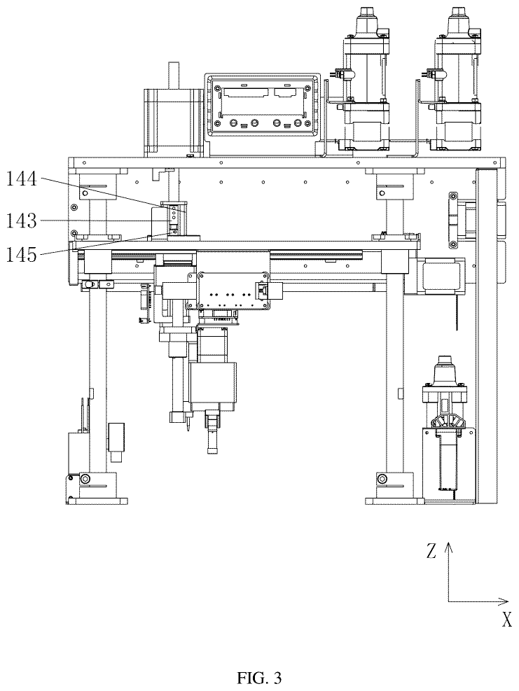

In an embodiment, as illustrated in FIG. 3, the filtration-press assembly 20 further includes a pressure sensor 145. The pressure sensor 145 is disposed on the movable plate 12. The pressure sensor 145 is configured to abut against the first lifting mechanism 14 to obtain pressure data. Alternatively, the pressure sensor 145 is disposed on the first lifting mechanism 14, and is configured to abut against the movable plate 12 to obtain pressure data. The pressure data is used to characterize a moving distance of the filtration-press plate 21 in the first direction Z.

The pressure sensor 145 is configured to sense a pressure signal and convert the pressure signal into an available output electrical signal according to a certain rule. Optionally, the pressure sensor 145 may be a piezoresistive sensor, a capacitive sensor, a piezoelectric sensor, an electromagnetic sensor, etc., or may be any feasible pressure sensor in the art, and there is no specific limitation.

Optionally, a certain relative movement can occur between the pressure sensor 145 and the first lifting mechanism 14 and/or the movable plate 12 in the first direction Z. When the filtration-press plate 21 moves in the first direction Z and abuts against the flash-filtration-bottle inner tube 2001, the pressure sensor 145 abuts against the first lifting mechanism 14 and/or the movable plate 12. At this time, the pressure sensor 145 can measure the pressure data generated by the abutment. The pressure data varies with different moving distances of the filtration-press plate 21 in the first direction Z. The pressing depth of the filtration-press plate 21 during filtration can be precisely controlled according to the variation in the pressure data.

The filtration-press assembly 20 further includes the pressure sensor 145, and the pressure data measured by the pressure sensor 145 can represent the moving distance of the filtration-press plate 21 in the first direction Z, so that the pressing depth of the filtration-press plate 21 during filtration can be precisely controlled. Therefore, the insufficient pressing of the filtration-press plate 21, causing the flash-filtration-bottle inner tube 2001 to not being fully pressed into the flash-filtration-bottle outer tube 2002 and causing the poor filtration effect, can be avoided, and the excessive pressing of the filtration-press plate 21, causing excessive force to be applied to and damage to the flash-filtration-bottle inner tube 2001 and the flash-filtration-bottle outer tube 2002, can also be avoided.

In an embodiment, as illustrated in FIG. 2 and FIG. 3, the first lifting mechanism 14 further includes a first floating joint 143 and a second floating joint 144. The first floating joint 143 is connected to the first transmission rod 142. The second floating joint 144 is fixedly connected to the movable plate 12 and is movably connected to the first transmission rod 142. The pressure sensor 145 is disposed on the second floating joint 144 and is located between the first floating joint 143 and the second floating joint 144. The pressure sensor 145 is configured to abut against the first floating joint 143 to obtain pressure data.

Optionally, the first floating joint 143 is fixedly connected to one end of the first transmission rod 142 away from the first lifting driving member 141. The second floating joint 144 is sleeved on the first transmission rod 142 and is fixedly connected to the movable plate 12. The second floating joint 144 is substantially cylindrical. The first floating joint 143 and the pressure sensor 145 are both accommodated in the second floating joint 144. The first floating joint 143 and the second floating joint 144 can move relative to each other, so that one end of the first floating joint 143 close to the first transmission rod 142 can abut against one end of the second floating joint 144 away from the movable plate 12. The pressure sensor 145 is fixedly connected to the second floating joint 144. The first floating joint 143 can move relative to the pressure sensor 145 and the second floating joint 144 in the first direction Z to drive the movable plate 12 to move, and the first floating joint 143 can abut against the pressure sensor 145 to obtain pressure data. Alternatively, the pressure sensor 145 is fixedly connected to the first floating joint 143. The first floating joint 143 and the pressure sensor 145 can move relative to the second floating joint 144 in the first direction Z, so that the pressure sensor 145 can abut against the second floating joint 144 or the movable plate 12 to obtain pressure data.

In an embodiment, the pressure sensor 145 is disposed on the second floating joint 144 and is opposite to the first floating joint 143. When the first lifting driving member 141 drives the first transmission rod 142 to drive the first floating joint 143 to move upward, the first floating joint 143 drives the second floating joint 144 and the movable plate 12 to move upward together. At this time, there is a separation distance between the first floating joint 143 and the pressure sensor 145. When the first lifting driving member 141 drives the first transmission rod 142 to drive the first floating joint 143 to move downward, the first floating joint 143 abuts against the pressure sensor 145, and the pressure data measured by the pressure sensor 145 increases. After that, the pressure sensor 145 drives the second floating joint 144 and the movable plate 12 to move downward together. When the pressure data measured by the pressure sensor 145 reaches the specified value, it indicates that the pressing depth of the filtration-press plate 21 is sufficient. At this time, the pressing can be stopped to avoid insufficient or excessive pressing depth of the filtration-press plate 21, thereby ensuring the filtration effect.

The first lifting mechanism 14 includes the first lifting driving member 141, the first transmission rod 142, the first floating joint 143, and the second floating joint 144, and the first lifting driving member 141 can drive the first transmission rod 142 to drive the first floating joint 143 to move in the first direction Z, so as to drive the second floating joint 144 and the movable plate 12 to move in the first direction Z, so that the transmission manner is simple and efficient. The first floating joint 143 can abut against the pressure sensor 145 during the pressing process. The pressure sensor 145 can obtain the pressure data according to the abutting force, and the pressing depth of the filtration-press plate 21 during filtration can be precisely controlled according to the variation in the pressure data.

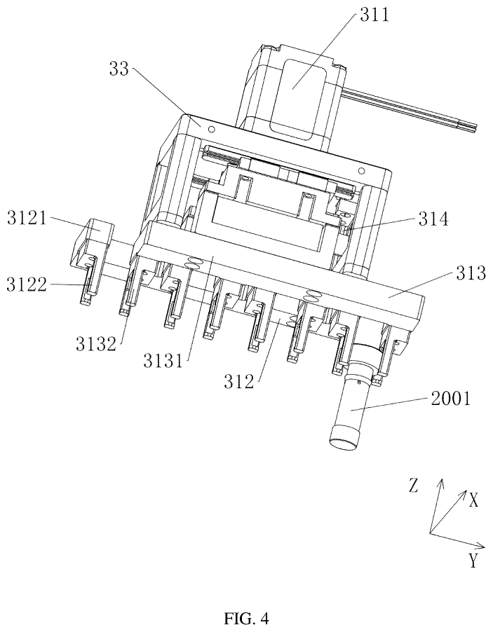

In an embodiment, as illustrated in FIG. 4, the first tube-clamping mechanism 31 includes a first clamping driving member 311, a first clamping portion 312, and a second clamping portion 313. The first clamping driving member 311 is disposed on the second sliding table 33. At least one of the first clamping portion 312 or the second clamping portion 313 is connected to the first clamping driving member 311. The first clamping driving member 311 is configured for relative movement between the first clamping portion 312 and the second clamping portion 313 to clamp the flash-filtration-bottle inner tube 2001.

The first clamping portion 312 may be of an integrated structure made by an integral molding process. Alternatively, the first clamping portion 312 may also be a split structure. The various parts of the first clamping portion 312 may be fixedly connected by means of welding, bonding, snapping, screwing, riveting, etc., without limitation. Similarly, the structure of the second clamping portion 313 can refer to the aforementioned first clamping portion 312, and will not be repeated here.

Optionally, at least one of the first clamping portion 312 or the second clamping portion 313 is slidably connected to the second sliding table 33, to move relative to each other under the drive of the first clamping driving member 311. The relative movement between the first clamping portion 312 and the second clamping portion 313 can be used to clamp a single flash-filtration-bottle inner tube 2001, or can be used to clamp multiple flash-filtration-bottle inner tubes 2001, without limitation.

Optionally, when the first clamping portion 312 and the second clamping portion 313 move towards each other, the first tube-clamping mechanism 31 clamps the flash-filtration-bottle inner tube 2001. When the first clamping portion 312 and the second clamping portion 313 move away from each other, the first tube-clamping mechanism 31 releases the flash-filtration-bottle inner tube 2001. Alternatively, when the first clamping portion 312 and the second clamping portion 313 move away from each other, the first tube-clamping mechanism 31 clamps the flash-filtration-bottle inner tube 2001. When the first clamping portion 312 and the second clamping portion 313 move towards each other, the first tube-clamping mechanism 31 releases the flash-filtration-bottle inner tube 2001, without limitation.

By providing the above-mentioned first tube-clamping mechanism 31, the flash-filtration-bottle inner tube 2001 can be clamped and moved to the specified position, and the operation is simple.

In an embodiment, as illustrated in FIG. 4, the first clamping portion 312 includes a first mounting plate 3121 and multiple groups of first fingers 3122. The multiple groups of first fingers 3122 are arranged at intervals on the first mounting plate 3121. Each group of first fingers 3122 includes at least one first finger 3122. The second clamping portion 313 includes a second mounting plate 3131 and multiple groups of second fingers 3132. The multiple groups of second fingers 3132 are arranged at intervals on the second mounting plate 3131. Each group of second fingers 3132 includes at least one second finger 3132. The multiple groups of first fingers 3122 and the multiple groups of second fingers 3132 are arranged in a one-to-one correspondence. The first fingers 3122 and the second fingers 3132 are configured to move relative to each other to clamp the flash-filtration-bottle inner tube 2001.

Optionally, both the first mounting plate 3121 and the second mounting plate 3131 are substantially in an “L” shape. The first mounting plate 3121 includes a first sub-plate (not shown) and a second sub-plate (not shown) that are connected to each other. The second mounting plate 3131 includes a third sub-plate (not shown) and a fourth sub-plate (not shown) that are connected to each other. The second sub-plate is connected to one end of the first sub-plate. The fourth sub-plate is connected to one end of the third sub-plate away from the second sub-plate. The first sub-plate and the third sub-plate extend in the same direction. The second sub-plate and the fourth sub-plate extend in the same direction. An extending direction of the first sub-plate may be the second direction X, or may intersect the second direction X (such as the third direction Y), without limitation. Exemplarily, both the first sub-plate and the third sub-plate extend in the third direction, and both the second sub-plate and the fourth sub-plate extend in the second direction. The second sub-plate and the fourth sub-plate are configured to limit the relative movement of the first sub-plate and the third sub-plate.

At least one of the first mounting plate 3121 or the second mounting plate 3131 is connected to the first clamping driving member 311. Optionally, both the first sub-plate and the third sub-plate extend in the third direction. The multiple groups of first fingers 3122 are arranged at intervals on the first sub-plate. The multiple groups of second fingers 3132 are arranged at intervals on the third sub-plate. The first clamping driving member 311 can drive the first mounting plate 3121 and the second mounting plate 3131 to move towards each other in the third direction.

The structure of the first finger 3122 may be the same as or similar to the structure of the second finger 3132. For example, both the first finger 3122 and the second finger 3132 may be cylindrical, rod-shaped, V-shaped, arc-shaped, etc., without limitation.

Optionally, the first finger 3122 is substantially in an “L” shape, the shorter edge of the “L” shape is fixedly connected to the first mounting plate 3121, and the longer edge of the “L” shape extends substantially in the first direction Z, thereby increasing the contact area between the first finger 3122 and the flash-filtration-bottle inner tube 2001 and increasing the clamping stability. The multiple first fingers 3122 in each group of first fingers 3122 are arranged at intervals. The spacing distances between any two adjacent groups of first fingers 3122 are substantially equal. The spacing distances between any two adjacent first fingers 3122 in each group of first fingers 3122 are also substantially equal. In a specific embodiment, there are four groups of first fingers 3122. The multiple groups of first fingers 3122 are arranged at intervals in the third direction. Each group of first fingers 3122 includes two first fingers 3122, and the two first fingers 3122 are spaced apart from each other in the second direction X. By providing the multiple groups of first fingers 3122 and the multiple groups of second fingers 3132, multiple flash-filtration-bottle inner tubes 2001 can be clamped and transported at the same time, thereby improving the experimental throughput and efficiency.

Similarly, the arrangement manner of the second fingers 3132 is similar to the arrangement manner of the first fingers 3122, so reference may be made thereto without further explanation.

In a specific embodiment, when the first finger 3122 and the second finger 3132 move towards each other, the first tube-clamping mechanism 31 clamps the flash-filtration-bottle inner tube 2001. When the first finger 3122 and the second finger 3132 move away from each other, the first tube-clamping mechanism 31 releases the flash-filtration-bottle inner tube 2001. During operation, the first tube-clamping mechanism 31 is driven by the first lifting mechanism 14 or the second lifting mechanism 34 to move in the first direction Z, and the first finger 3122 and the second finger 3132 are located at both sides of the flash-filtration-bottle inner tube 2001. Then, the first clamping driving member 311 drives the first clamping portion 312 and the second clamping portion 313 to move relative to each other, to reduce a distance between the first finger 3122 and the second finger 3132 until both the first finger 3122 and the second finger 3132 abut against a tube wall of the flash-filtration-bottle inner tube 2001, thereby completing the clamping action of the first tube-clamping mechanism 31. Subsequently, the first translation mechanism 22 drives the first sliding table 23 to move in the second direction X, so as to drive the first tube-clamping mechanism 31 to move in the second direction X until the flash-filtration-bottle inner tube 2001 clamped between the first finger 3122 and the second finger 3132 moves above the flash-filtration-bottle outer tube 2002. At this time, the first tube-clamping mechanism 31 can be driven by the first lifting mechanism 14 or the second lifting mechanism 34 to adjust a distance between the flash-filtration-bottle inner tube 2001 and the flash-filtration-bottle outer tube 2002, so that part of the flash-filtration-bottle inner tube 2001 extends into the flash-filtration-bottle outer tube 2002, thereby preventing the flash-filtration-bottle inner tube 2001 from falling out of the flash-filtration-bottle outer tube 2002 after the first tube-clamping mechanism 31 is released. After the adjustment is completed, the first clamping driving member 311 drives the first clamping portion 312 and the second clamping portion 313 to move relative to each other, so that the first finger 3122 and the second finger 3132 move away from each other to release the flash-filtration-bottle inner tube 2001, thereby completing the movement and placement of the flash-filtration-bottle inner tube 2001.

By providing the above-mentioned first clamping portion 312 and second clamping portion 313, the first tube-clamping mechanism 31 can simultaneously clamp and move multiple flash-filtration-bottle inner tubes 2001, with high experimental efficiency. In addition, the moving distances of multiple groups of first fingers 3122 and multiple groups of second fingers 3132 are equal, so that there is no error in the moving distances, thereby improving the accuracy of batch operations.

In an embodiment, as illustrated in FIG. 4, the first tube-clamping mechanism 31 further includes a first transmission member 314 and a second transmission member (not shown in the figure). The first clamping driving member 311 is connected to the first transmission member 314 and the second transmission member respectively. The first transmission member 314 is fixedly connected to the first clamping portion 312. The second transmission member is fixedly connected to the second clamping portion 313. The first clamping driving member 311 is configured to drive the first transmission member 314 and the second transmission member to move in opposite directions. At least one of the first transmission member 314 or the second transmission member includes a rack.

The fixed connection manner between the first transmission member 314 and the first clamping portion 312 may be welding, bonding, snapping, screwing, riveting, etc., without limitation. Optionally, the first transmission member 314 is connected to a surface of the first mounting plate 3121 facing away from the first finger 3122. Optionally, the first clamping driving member 311 is configured to drive the first transmission member 314 to move, to drive the first clamping portion 312 to move. Alternatively, the first clamping driving member 311 may also be configured to drive the first transmission member 314 to rotate, to drive the first clamping portion 312 to move, without limitation. The connection manner between the second transmission member and the second clamping portion 313 may refer to the connection manner between the first transmission member 314 and the first clamping portion 312, without specific limitation.

Optionally, at least one of the first transmission member 314 or the second transmission member may be a single rack, a rack set formed by multiple engaged racks, or a rack in combination with other transmission structures (such as gears), without specific limitation.

In a specific embodiment, as illustrated in FIG. 4, the first clamping driving member 311 is a motor. The first tube-clamping mechanism 31 further includes a transmission gear (not shown in the figure). The transmission gear is connected to the first clamping driving member 311 and is configured to rotate under the drive of the first clamping driving member 311. Both the first transmission member 314 and the second transmission member are racks and are engaged with the transmission gear respectively. When the first clamping driving member 311 drives the transmission gear to rotate, the first transmission member 314 and the second transmission member respectively drive the first clamping portion 312 and the second clamping portion 313 to move in opposite directions, so as to clamp or release the flash-filtration-bottle inner tube 2001. In addition, in order to ensure the moving stability of the first clamping portion 312 and the second clamping portion 313, a guiding structure (such as a slide rail) may be additionally provided to guide the movement of the first clamping portion 312 and the second clamping portion 313.

The first tube-clamping mechanism 31 further includes the first transmission member 314 and the second transmission member, the first clamping driving member 311 is configured to drive the first transmission member 314 and the second transmission member to move in opposite directions and drive the first clamping portion 312 and the second clamping portion 313 to move relative to each other, so that the transmission manner is simple and reliable.

In an embodiment, as illustrated in FIG. 1 and FIG. 2, the flash-filtration apparatus 100 further includes a liquid-dispensing assembly 40. The liquid-dispensing assembly 40 is connected to the filtration-press assembly 20 and is configured to dispense sample liquid or diluent to the flash-filtration-bottle outer tube 2002. The liquid-dispensing assembly 40 includes a liquid-dispensing needle 41 and a liquid-dispensing pump 42. The liquid-dispensing needle 41 is connected to the filtration-press plate 21. The liquid-dispensing pump 42 is in communication with the liquid-dispensing needle 41 and is configured to output the sample liquid or the diluent to the liquid-dispensing needle 41.

The liquid-dispensing needle 41 is configured to add a fixed volume of liquid into the container. Optionally, the liquid-dispensing needle 41 is configured to add the sample liquid or the diluent into the flash-filtration-bottle outer tube 2002. The liquid-dispensing needle 41 may be a fixed-volume liquid-phase sample-addition needle or an adjustable-volume liquid-phase sample-addition needle, or any other feasible liquid-dispensing needle 41 in the art, without limitation. The liquid-dispensing needle 41 can meet the high-accuracy sample-addition requirements in small-volume liquid operations, thereby significantly reducing errors caused by manual dispensing, and improving the accuracy and reliability of the experiment.

Optionally, the number of liquid-dispensing needles 41 may be one or multiple, without specific limitation. When the number of liquid-dispensing needles 41 is multiple, the multiple liquid-dispensing needles 41 may simultaneously deliver the same liquid into different flash-filtration-bottle outer tube 2002, or deliver different liquids into different flash-filtration-bottle outer tube 2002, without limitation. Optionally, the number of liquid-dispensing needles 41 corresponds to the number of first tube-clamping mechanisms 31, so that the flash-filtration bottles in the same operation batch can be operated. In a specific embodiment, there are four liquid-dispensing needles 41 arranged at intervals to improve the experimental throughput and efficiency. The liquid-dispensing needles 41 may be disposed at an edge of the filtration-press plate 21 to minimize the interference between components.

Optionally, the liquid-dispensing needle 41 is directly connected and fixed to the filtration-press plate 21. Alternatively, as illustrated in FIG. 1, the liquid-dispensing assembly 40 further includes a liquid-dispensing-needle mounting seat 43. The liquid-dispensing-needle mounting seat 43 is fixedly connected to the filtration-press plate 21, and the liquid-dispensing needle 41 is mounted on the liquid-dispensing-needle mounting seat 43 and extends away from the top plate 13.

The liquid-dispensing pump 42 is configured to deliver liquid, such as sample liquid, diluent, or cleaning liquid, into the liquid-dispensing needle 41. The liquid-dispensing pump 42 may be disposed on the support assembly 10. Specifically, the liquid-dispensing pump 42 may be disposed on the top plate 13, the support post 11, or other parts of the support assembly 10, without specific limitation. Optionally, the liquid-dispensing pump 42 may be a plunger pump, a diaphragm pump, a peristaltic pump, a piston pump, etc., or any feasible apparatus for delivering liquid in the art, without specific limitation.

Optionally, there may be one or more liquid-dispensing pumps 42, without specific limitation. When there are multiple liquid-dispensing pumps 42, the multiple liquid-dispensing pumps 42 may simultaneously deliver the same liquid to multiple liquid-dispensing needles 41, or may respectively deliver different liquids to one or more liquid-dispensing needles 41. The selection may be made as needed, without limitation.

By providing the above-mentioned liquid-dispensing assembly 40, sample liquid or diluent can be added to the flash-filtration-bottle outer tube 2002 without manual operation, thereby enabling the high-accuracy sample-addition requirements in liquid operations and further improving the efficiency and safety of experiments.

In an embodiment, as illustrated in FIG. 1 and FIG. 2, the liquid-dispensing assembly 40 further includes a cleaning mechanism 44. The cleaning mechanism 44 includes a cleaning tank 441 and a cleaning pump 442. The cleaning pump 442 is in communication with the cleaning tank 441.

The cleaning tank 441 is configured for accommodation of at least part of the liquid-dispensing needle 41 and collection of waste cleaning liquid. Optionally, the cleaning tank 441 is fixedly connected to the support assembly 10, and the connection manner between the cleaning tank 441 and the support assembly 10 may be direct connection or indirect connection, without limitation. The cleaning pump 442 is configured to discharge the waste cleaning liquid from the cleaning tank 441. Optionally, the cleaning pump 442 may be a plunger pump, a diaphragm pump, a peristaltic pump, a piston pump, etc., without limitation.

In a specific embodiment, as illustrated in FIG. 1, the cleaning mechanism 44 further includes a cleaning-tank mounting frame 443. The cleaning-tank mounting frame 443 is fixedly connected to the support assembly 10. The cleaning-tank mounting frame 443 is configured for mounting of the cleaning tank 441. The cleaning tank 441 is close to one end of the support post 11 away from the top plate 13, so that the interference between the cleaning tank 441 and other parts of the filtration-press assembly 20 can be avoided, and the insertion of the liquid-dispensing needle 41 into the cleaning tank 441 is easy. The cleaning pump 442 is in communication with and adjacent to the cleaning tank 441, thereby facilitating the timely discharge of the waste cleaning liquid from the cleaning tank 441.

When the liquid-dispensing needle 41 dispenses different sample liquids or diluents to the flash-filtration-bottle outer tube 2002, to avoid contamination of the subsequent liquid by the previous liquid, the liquid-dispensing needle 41 needs to be cleaned before dispensing the subsequent liquid. For example, in the first experiment, diluent B is added to sample liquid A. In the second experiment, diluent D needs to be added to sample liquid C. Then, before adding diluent D, the liquid-dispensing needle 41 is inserted into the cleaning tank 441, and the liquid-dispensing pump 42 pumps diluent D into the liquid-dispensing needle 41. Diluent D flushes part of the diluent B remaining in the pipeline and on the inner wall of the liquid-dispensing needle 41. The flushed cleaning liquid accumulates in the cleaning tank 441 to simultaneously clean the outer wall of the liquid-dispensing needle 41. Then, the cleaning pump 442 pumps out the waste cleaning liquid from the cleaning tank 441 to complete the discharge of the waste liquid.

By providing the above-mentioned cleaning mechanism 44, the inner and outer walls of the liquid-dispensing needle 41 can be cleaned. After the cleaning is completed, the cleaning pump 442 can discharge the waste cleaning liquid from the cleaning tank 441, thereby avoiding cross-contamination when the liquid-dispensing needle 41 adds different sample liquids or diluents and ensuring the accuracy of the experiment.

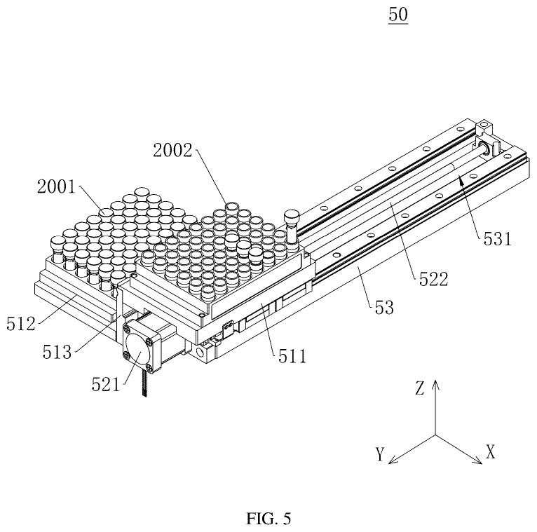

In an embodiment, as illustrated in FIG. 5 to FIG. 7, the flash-filtration apparatus 100 further includes a flash-filtration-bottle transfer assembly 50. The flash-filtration-bottle transfer assembly 50 includes a flash-filtration-bottle tray placement seat 51. The flash-filtration-bottle tray placement seat 51 is configured for placement of the flash-filtration-bottle inner tube 2001 and/or the flash-filtration-bottle outer tube 2002.

The flash-filtration-bottle tray placement seat 51 is configured for placement of a flash-filtration-bottle tray. The multiple flash-filtration-bottle inner tubes 2001 and/or flash-filtration-bottle outer tubes 2002 are contained on the flash-filtration-bottle tray, thereby facilitating batch operations on the flash-filtration-bottle inner tubes 2001 and/or the flash-filtration-bottle outer tubes 2002 placed in a whole tray. The flash-filtration-bottle tray placement seat 51 may be substantially rectangular, square, trapezoidal, etc. The shape of the flash-filtration-bottle tray placement seat 51 only needs to correspond to the shape of the flash-filtration-bottle tray, without limitation.

Optionally, the flash-filtration-bottle trays may have different specifications to hold different numbers of flash-filtration-bottle inner tubes 2001 and/or flash-filtration-bottle outer tubes 2002. For example, as illustrated in FIG. 5 and FIG. 17, forty-eight flash-filtration-bottle inner tubes 2001 or forty-eight flash-filtration-bottle outer tubes 2002 may be placed on the flash-filtration-bottle tray. Alternatively, as illustrated in FIG. 18, twelve flash-filtration-bottle inner tubes 2001 or twelve flash-filtration-bottle outer tubes 2002 may be placed on the flash-filtration-bottle tray.

Optionally, the flash-filtration-bottle tray placement seat 51 is configured for placement of a single flash-filtration-bottle tray. Multiple flash-filtration-bottle inner tubes 2001 are distributed in an array of multiple rows and columns on the flash-filtration-bottle tray, and multiple flash-filtration-bottle outer tubes 2002 are distributed in an array of multiple rows and columns on the flash-filtration-bottle tray. Optionally, the flash-filtration-bottle inner tubes 2001 and the flash-filtration-bottle outer tubes 2002 are alternately arranged in a column direction. The second direction X is the column direction of the array distribution of multiple flash-filtration bottles. That is, in the second direction X, one row is the flash-filtration-bottle inner tubes 2001, the next row is the flash-filtration-bottle outer tubes 2002, and the following row is the flash-filtration-bottle inner tubes 2001, and so on alternately. Alternatively, the flash-filtration-bottle tray placement seat 51 is configured for placement of two flash-filtration-bottle trays, one of the two flash-filtration-bottle trays is configured for placement of the flash-filtration-bottle inner tubes 2001, and the other of the two flash-filtration-bottle trays is configured for placement of the flash-filtration-bottle outer tubes 2002. Alternatively, the flash-filtration-bottle inner tubes 2001 and the flash-filtration-bottle outer tubes 2002 may also be placed in any other feasible way, without limitation.

By providing the above-mentioned flash-filtration-bottle transfer assembly 50, the flash-filtration-bottle inner tubes 2001 and the flash-filtration-bottle outer tubes 2002 can be held in batches, thereby facilitating the batch experimental operations of the filtration-press assembly 20 and the first clamping assembly 30, improving the experimental efficiency, and meeting the requirements of high-throughput experimental processing.

In an embodiment, as illustrated in FIG. 5, the flash-filtration-bottle tray placement seat 51 includes a first tray-placement-seat 511 and a second tray-placement-seat 512. The first tray-placement-seat 511 and the second tray-placement-seat 512 are arranged in the second direction X.

The first tray-placement-seat 511 is spaced apart from the second tray-placement-seat 512 in the first direction Z. The first tray-placement-seat 511 is closer to the filtration-press plate 21 than the second tray-placement-seat 512 in the first direction Z.

The first tray-placement-seat 511 and the second tray-placement-seat 512 are arranged adjacent to each other in the second direction X. The first tray-placement-seat 511 and the second tray-placement-seat 512 may or may not be connected. Optionally, the first tray-placement-seat 511 and the second tray-placement-seat 512 may be of an integrated structure or a split structure. The first tray-placement-seat 511 may be fixedly connected to the second tray-placement-seat 512 by means of welding, bonding, snapping, screwing, riveting, etc., without limitation.

Optionally, the flash-filtration-bottle tray placement seat 51 further includes a connection plate 513. In the first direction Z, one end of the connection plate 513 is connected to the first tray-placement-seat 511, and the other end of the connection plate 513 is connected to the second tray-placement-seat 512. The first tray-placement-seat 511 and the second tray-placement-seat 512 are located at different sides of the connection plate 513. That is, the first tray-placement-seat 511, the connection plate 513, and the second tray-placement-seat 512 may be substantially in a “Z” shape. Optionally, the connection plate 513 is substantially parallel to the first direction Z.

One of the first tray-placement-seat 511 and the second tray-placement-seat 512 is configured for placement of the flash-filtration-bottle inner tube 2001, and the other of the first tray-placement-seat 511 and the second tray-placement-seat 512 is configured for placement of the flash-filtration-bottle outer tube 2002. Optionally, the first tray-placement-seat 511 is configured for placement of the flash-filtration-bottle inner tube 2001, and the second tray-placement-seat 512 is configured for placement of the flash-filtration-bottle outer tube 2002. Alternatively, as illustrated in FIG. 5, the first tray-placement-seat 511 is configured for placement of the flash-filtration-bottle outer tube 2002, and the second tray-placement-seat 512 is configured for placement of the flash-filtration-bottle inner tube 2001, without limitation. Optionally, there are multiple flash-filtration-bottle inner tubes 2001 and multiple flash-filtration-bottle outer tubes 2002, and the number and arrangement of the flash-filtration-bottle outer tubes 2002 on the first tray-placement-seat 511 correspond to the number and arrangement of the flash-filtration-bottle inner tubes 2001 on the second tray-placement-seat 512.

With such an arrangement, for the flash-filtration-bottle inner tubes 2001 and the flash-filtration-bottle outer tubes 2002 in the same batch of operations, distances between the flash-filtration-bottle inner tubes 2001 in the second direction X and distances between the flash-filtration-bottle outer tubes 2002 in the second direction X are equal. That is, during the process when the flash-filtration apparatus 100 moves in the second direction X and places the flash-filtration-bottle inner tubes 2001 into the flash-filtration-bottle outer tubes 2002 in batches, the distance of each movement of the first sliding table 23 in the second direction X does not need to be adjusted again, thereby improving the experimental efficiency.

The flash-filtration-bottle tray placement seat 51 may be fixed or movable in the second direction X and/or the third direction Y. When the flash-filtration-bottle tray placement seat 51 moves, the flexibility of the flash-filtration apparatus 100 can be improved, and the transfer time of the flash-filtration bottles can be shortened.

In an embodiment, as illustrated in FIG. 17 and FIG. 18, the filtration-press plate 21 is spaced apart from the first tube-clamping mechanism 31 in the third direction Y. The flash-filtration-bottle tray placement seat 51 includes a first tray-placement-seat 511 and a second tray-placement-seat 512, and the first tray-placement-seat 511 and the second tray-placement-seat 512 are arranged in the third direction Y. With such an arrangement, the first tray-placement-seat 511 and the second tray-placement-seat 512 can move in the third direction Y, so as to be located below the filtration-press plate 21 or the first tube-clamping mechanism 31, and it is convenient for the first tube-clamping mechanism 31 to clamp different flash-filtration bottles in the second direction X.

In an embodiment, as illustrated in FIG. 5 to FIG. 7, the flash-filtration-bottle transfer assembly 50 further includes a first moving mechanism 52. The first moving mechanism 52 is connected to the flash-filtration-bottle tray placement seat 51 and is configured to drive the flash-filtration-bottle tray placement seat 51 to move in the second direction X and/or the third direction Y. The third direction Y intersects both the first direction Z and the second direction X. Preferably, the third direction Y is perpendicular to both the first direction Z and the second direction X.

Optionally, at least one of the first tray-placement-seat 511 or the second tray-placement-seat 512 is connected to the first moving mechanism 52. The first moving mechanism 52 can drive the first tray-placement-seat 511 and the second tray-placement-seat 512 to move synchronously. When the first tray-placement-seat 511 is connected to the second tray-placement-seat 512, the first moving mechanism 52 may be connected to the first tray-placement-seat 511 or the second tray-placement-seat 512. When the first tray-placement-seat 511 is not connected to the second tray-placement-seat 512, the first moving mechanism 52 may be connected to both the first tray-placement-seat 511 and the second tray-placement-seat 512. Exemplarily, as illustrated in FIG. 5, the first tray-placement-seat 511 is connected to the second tray-placement-seat 512, and the first moving mechanism 52 is connected to the first tray-placement-seat 511, so that by driving the first tray-placement-seat 511 to move, the second tray-placement-seat 512 is driven to move synchronously.

In an embodiment, as illustrated in FIG. 18, the flash-filtration apparatus 100 further includes a baffle plate 54. The baffle plate 54 is disposed on the support assembly 10 and is spaced apart from the flash-filtration-bottle tray placement seat 51 in the first direction Z. The baffle plate 54 defines a through hole 541 in the first direction Z. An aperture of the through hole 541 is less than an outer diameter of the flash-filtration-bottle inner tube 2001 (such as an outer diameter of a tube cap). The first moving mechanism 52 is configured to drive the flash-filtration-bottle tray placement seat 51 to move to the baffle plate 54.

Optionally, the baffle plate 54 may be fixedly connected to the support post 11 or the support frame 16 of the support assembly 10. The connection manner between the baffle plate 54 and the support assembly 10 may be welding, bonding, snapping, screwing, riveting, magnetic connection, etc., without limitation. The shape of the baffle plate 54 is not limited and may be rectangular, square, circular, regular polygonal, etc.

Optionally, the number of through holes 541 may be one or more, without limitation. Optionally, the number of through holes 541 is equal to the number of flash-filtration-bottle inner tubes 2001 held in the flash-filtration-bottle tray on the flash-filtration-bottle tray placement seat 51. When the flash-filtration-bottle tray placement seat 51 moves to the baffle plate 54 and is aligned with the baffle plate 54, the through hole 541 falls within an orthographic projection of the flash-filtration-bottle inner tube 2001 on the baffle plate 54.

After the filtration is completed, the filtrate may also be extracted from the flash-filtration-bottle inner tube 2001 after filtration. In an embodiment, as illustrated in FIG. 18, the first moving mechanism 52 can drive the flash-filtration-bottle tray placement seat 51 to move in the third direction Y. When it is necessary to sample the filtrate, the flash-filtration-bottle tray placement seat 51 can be moved to the baffle plate 54 under the drive of the first moving mechanism 52, and the pipetting assembly 60 (such as a puncture needle, etc.) can be used for sampling. By providing the baffle plate 54, the baffle plate 54 can prevent the flash-filtration-bottle inner tube 2001 from being lifted up together with the pipetting assembly 60 after the sampling is completed.

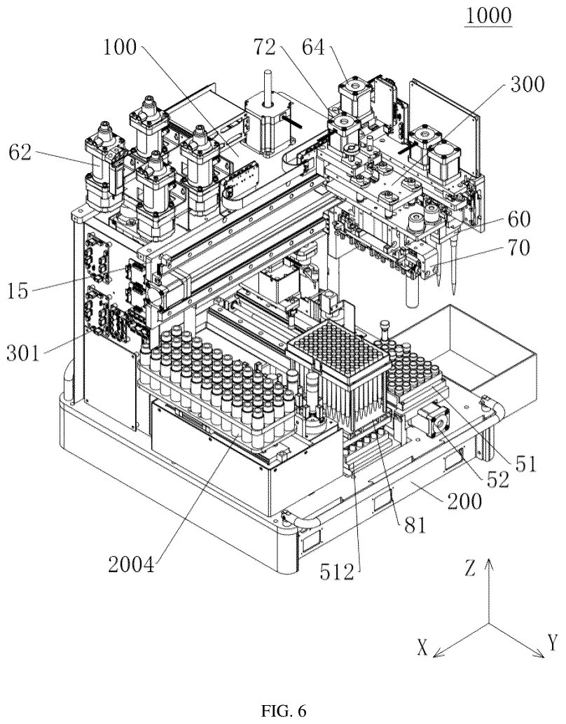

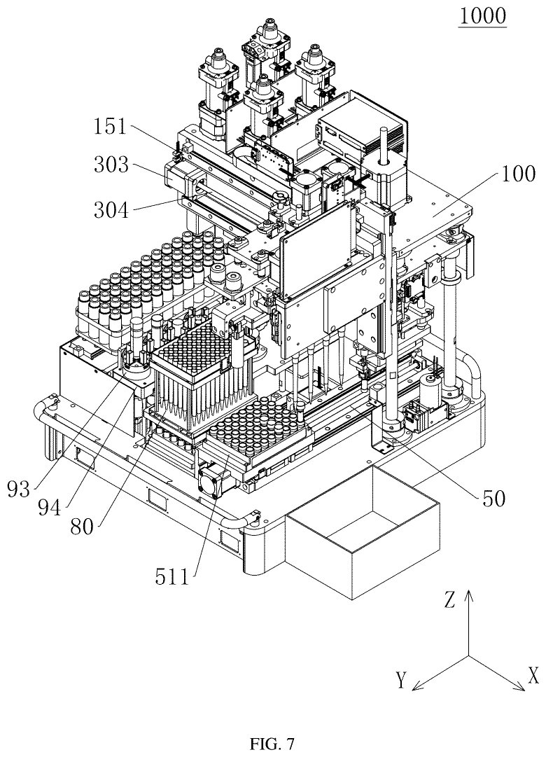

Reference can be made to FIG. 6 and FIG. 7. An experimental platform 1000 is further provided in embodiments of the present disclosure. The experimental platform 1000 includes a base 200 and the flash-filtration apparatus 100 in the embodiments of the present disclosure. The support assembly 10 of the flash-filtration apparatus 100 is mounted on the base 200.

The base 200 is configured to carry various modules of the experimental platform 1000. The base 200 may be made of a material with high structural strength, specifically a metal material, high-strength plastic, ceramic, etc. The metal material may be, for example, aluminum, aluminum alloy, magnesium alloy, iron or iron alloy, etc. Optionally, the base 200 may be composed of a mounting bottom plate, a bottom sheet metal, a chassis support post, a bottom cover plate, etc. Front and rear handles, a main screen, a power supply, and various types of drive boards may be mounted on the base 200.

The base 200 may be of an integrated structure, that is, the base 200 is of an integrated structure made by an integral forming process. The integral forming process may specifically be stamping, casting, etc., without limitation. The base 200 may also be of a split structure, and the various parts of the base 200 can be connected and fixed by means of welding, bonding, snapping, screwing, riveting, etc. The base 200 may also adopt any other feasible seat body or platform structure for support in the art, without specific limitation.

Optionally, the support post 11 of the support assembly 10 is fixedly connected to the base 200, and the connection manner may be welding, bonding, snapping, screwing, riveting, etc., without limitation.

The experimental platform 1000 is provided with multiple workstations, such as a flash-filtration workstation where the flash-filtration apparatus 100 operates as mentioned above. The experimental platform 1000 further includes a pipetting workstation, a cap-opening workstation, etc. The various workstations are orderly arranged on the experimental platform 1000, thereby reducing the transport and waiting time between various workstations, and enabling the flow between different workstations to be more convenient.

Optionally, the experimental platform 1000 further includes a controller (not shown). The controller serves as a control center of the entire experimental platform 1000 and is configured to issue work instructions to the corresponding modules in a timely manner respectively, so as to realize the collaborative work between the various modules. For example, the controller may adopt one or more of a programmable logical controller (PLC), a microcontroller, computer control software, etc. Optionally, the controller is disposed on the base 200.

For the experimental platform 1000 in the embodiment of the present disclosure, by providing the base 200 and the flash-filtration apparatus 100 in the embodiment of the present disclosure, and mounting the flash-filtration apparatus 100 on the base 200, the overall integration degree of the experimental platform 1000 is high, the operation is convenient, the experimental efficiency can be improved, the contamination that may arise from manual operation can be reduced, the experimental error can be reduced, and the experimental safety can be improved.

In an embodiment, as illustrated in FIG. 5 to FIG. 7, the flash-filtration-bottle transfer assembly 50 includes a flash-filtration-bottle tray placement seat 51 and a first moving mechanism 52. The flash-filtration-bottle tray placement seat 51 is slidably connected to the base 200 and is movable in the second direction X and/or the third direction Y. The first moving mechanism 52 is disposed on the base 200 and is connected to the flash-filtration-bottle tray placement seat 51. The first moving mechanism 52 is configured to drive the flash-filtration-bottle tray placement seat 51 to move relative to the base 200. The flash-filtration-bottle tray placement seat 51 is configured for placement of the flash-filtration-bottle inner tube 2001 and the flash-filtration-bottle outer tube 2002.

Optionally, the flash-filtration-bottle transfer assembly 50 further includes a mounting base 53. The mounting base 53 is fixedly connected to the base 200. The flash-filtration-bottle tray placement seat 51 can move in the third direction Y relative to the mounting base 53. Both the first moving mechanism 52 and the flash-filtration-bottle tray placement seat 51 are disposed on the mounting base 53, thereby facilitating the overall mounting and handling of the flash-filtration-bottle transfer assembly 50.

The first moving mechanism 52 may be any feasible driving transmission structure in the art. Optionally, the first moving mechanism 52 includes a first moving driving member 521. The first moving driving member 521 is disposed on the mounting base 53. The first moving driving member 521 may be a motor, an oil cylinder, an air cylinder, etc., without limitation.

Optionally, a sliding guide rail 531 is provided on a surface of the mounting base 53 facing away from the base 200. The flash-filtration-bottle tray placement seat 51 may be slidably connected to the sliding guide rail 531 through a slider and can move in the third direction Y relative to the sliding guide rail 531.

Optionally, the first moving driving member 521 may be a linear motor. The first moving mechanism 52 further includes a second transmission portion 522. The second transmission portion 522 includes a lead screw and nut pair. The lead screw is connected to a drive shaft of the first moving driving member 521 through a coupling. The nut is connected to the flash-filtration-bottle tray placement seat 51. Optionally, the lead screw of the second transmission portion 522 extends in the third direction Y. The first moving driving member 521 can drive the lead screw to rotate, enabling the nut to move linearly on the lead screw, and thereby driving the flash-filtration-bottle tray placement seat 51 to move in the third direction Y on the mounting base 53.

Optionally, at least one of the first tray-placement-seat 511 or the second tray-placement-seat 512 is connected to the first moving mechanism 52. The first moving mechanism 52 can drive the first tray-placement-seat 511 and the second tray-placement-seat 512 to move synchronously. For specific details, reference can be made to the aforementioned relevant content, and it will not be repeated here.

By providing the above-mentioned flash-filtration-bottle transfer assembly 50 to drive the flash-filtration-bottle tray placement seat 51 to move in the third direction Y, the flash-filtration-bottle tray placement seat 51 can rapidly move between different workstations on the experimental platform 1000. In combination with the filtration-press assembly 20 and the first clamping assembly 30 that move in the second direction X, the spatial distance between different operation workstations on the experimental platform 1000 during the experiment can be shortened, thereby reducing the transport time between each operation step.

In an embodiment, as illustrated in FIG. 6 to FIG. 12, the experimental platform 1000 further includes a sampling apparatus 300. The sampling apparatus 300 includes a pipetting assembly 60. The pipetting assembly 60 is configured to transfer sample liquid or diluent into the flash-filtration-bottle outer tube 2002, or the pipetting assembly 60 is configured to extract filtrate from the flash-filtration-bottle inner tube 2001 after filtration.

Optionally, the pipetting assembly 60 includes a pipette-tip mounting seat 61. The pipette-tip mounting seat 61 is configured for mounting of the pipette tip 2003, and the sample liquid or the diluent is transferred into the flash-filtration-bottle outer tube 2002 through the pipette tip 2003.

The pipette tip 2003, namely a tip head, is also known as a pipettor tip, is a disposable pipette tip for experiments and capable of storing a certain volume of liquid. Optionally, the material of the pipette tip 2003 may be selected according to different sample characteristics, such as polytetrafluoroethylene, polypropylene, silica gel, glass, quartz, etc., without limitation.

Optionally, a single pipette tip 2003 may be mounted on the pipetting assembly 60, or multiple pipette tips 2003 may be mounted on the pipetting assembly 60 simultaneously, without specific limitation. Optionally, multiple pipette tips 2003 can be mounted on the pipetting assembly 60 through the pipette-tip mounting seat 61, so that operations can be performed on the multiple pipette tips 2003 simultaneously, thereby realizing simultaneous pipetting operations on the multiple flash-filtration-bottle outer tubes 2002, meeting the requirements of high-throughput operations, and realizing batch pipetting operations.

Optionally, the pipetting assembly 60 can move in the first direction Z relative to the base 200, thereby facilitating the liquid dispensing and aspiration by the pipette tip 2003. Optionally, the pipetting assembly 60 can also move in the second direction X and/or the third direction Y relative to the base 200, so that the sample liquid or the diluent can be transferred to different workstations to perform different operations on the sample liquid or the diluent at different workstations, thereby reducing manual operations and improving experimental efficiency.

Optionally, the pipetting assembly 60 further includes a puncture needle (not shown). The puncture needle can extract the filtrate from the flash-filtration-bottle inner tube 2001 after filtration.

Optionally, the pipetting assembly 60 further includes a pipetting pump 62. The pipetting pump 62 is in communication with the pipette tip 2003 or the puncture needle, and is configured to drive the pipette tip 2003 or the puncture needle to aspirate or dispense liquid. The pipetting pump 62 may be disposed on the top plate 13, the support post 11, or other positions on the experimental platform 1000, without specific limitation. Optionally, the pipetting pump 62 may be a plunger pump, a diaphragm pump, a peristaltic pump, a piston pump, etc., or any feasible apparatus for transporting liquid in the art, without specific limitation. Optionally, multiple pipetting pumps 62 can be provided, and the number of pipette tips 2003 or puncture needles is equal to the number of pipetting pumps 62, and the pipetting pumps 62 are connected to the pipette tips 2003 or puncture needles in a one-to-one correspondence. With such an arrangement, simultaneous pipetting operations can be performed on the multiple flash-filtration-bottle outer tubes 2002 or simultaneous sampling operations can be performed on the multiple flash-filtration-bottle inner tubes 2001, thereby improving the experimental throughput and efficiency.

Exemplarily, the pipetting assembly 60 is configured to transfer the sample liquid into the flash-filtration-bottle outer tube 2002, and the liquid-dispensing assembly 40 is configured to dispense the diluent into the flash-filtration-bottle outer tube 2002, and vice versa, without limitation.

By providing the above-mentioned pipetting assembly 60, the transfer work procedure of the sample liquid or the diluent can be completed on the experimental platform 1000 without setting up an additional liquid transfer platform, so that flow between different operation steps is more convenient, and the experimental efficiency can be improved.

In an embodiment, as illustrated in FIG. 6, the support assembly 10 further includes a side plate 15. The side plate 15 is fixedly connected to the top plate 13 and/or the support post 11. The side plate 15 may extend in the second direction X or the third direction Y.

The support assembly 10 may be of an integrated structure, that is, the support assembly 10 may be of an integrated structure made by an integral forming process. The integral forming process may specifically be stamping, casting, etc., without limitation. The support assembly 10 may also be of a split structure, and the side plate 15, the top plate 13, and the support post 11 may be connected and fixed by means of welding, bonding, snapping, screwing, riveting, etc. The side plate 15 can enhance the overall structural stability of the support assembly 10, the side plate 15 can also serve as a support base for the sampling apparatus 300, thereby realizing structure reuse, simplifying the structural arrangement, and realizing lightweight design of the experimental platform 1000.

Reference can be made to FIG. 6 to FIG. 8. The sampling apparatus 300 further includes a second translation mechanism 301 and a third sliding table 302. The second translation mechanism 301 is disposed on the side plate 15. The third sliding table 302 is slidably connected to the side plate 15 in the second direction X or the third direction Y. The second translation mechanism 301 is connected to the third sliding table 302 and is configured to drive the third sliding table 302 to move relative to the side plate 15. The pipetting assembly 60 is slidably connected to the third sliding table 302 and is movable relative to the third sliding table 302 in the first direction Z.

The shape of the third sliding table 302 may be block-shaped, plate-shaped, columnar, or other irregular shapes, etc., without limitation. Optionally, the third sliding table 302 is slidably connected to the side plate 15 in the second direction X. A second slide rail 151 is provided on a surface of the side plate 15 facing away from the filtration-press assembly 20. The second slide rail 151 extends in the second direction X. The third sliding table 302 is slidably connected to the second slide rail 151 and is configured to move relative to the second slide rail 151 in the second direction X under the drive of the second translation mechanism 301. The pipetting assembly 60 is slidably connected to the third sliding table 302 and is located at one side of the third sliding table 302 facing away from the second slide rail 151.

The second translation mechanism 301 may be any feasible driving transmission structure in the art. Optionally, the second translation mechanism 301 includes a second translation driving member 303. The second translation driving member 303 may be a motor, an oil cylinder, an air cylinder, etc., without limitation. Optionally, the second translation driving member 303 is disposed on the side plate 15, and the second translation driving member 303 and the side plate 15 can be connected and fixed by means of welding, bonding, snapping, screwing, riveting, etc.

Optionally, the second translation driving member 303 is a linear motor. The second translation mechanism 301 further includes a third transmission portion 304. The third transmission portion 304 includes a lead screw and nut pair. The screw is connected to a drive shaft of the linear motor through a coupling and extends in the second direction X. The nut is connected to the third sliding table 302. The linear motor can drive the lead screw to rotate, causing the nut to move linearly on the lead screw, and thereby driving the third sliding table 302 to move along the second slide rail 151 relative to the side plate 15 in the second direction X.

By arranging the third sliding table 302 to be slidably connected to the side plate 15 in the second direction X, the pipetting assembly 60 connected to the third sliding table 302 can move in the second direction X under the action of the third sliding table 302. The pipette tip 2003 of the pipetting assembly 60 can first aspirate the sample liquid or the diluent from other workstations. When the third sliding table 302 drives the pipetting assembly 60 to move in the second direction X to be located above the flash-filtration-bottle outer tube 2002, the pipette tip 2003 can dispense the aspirated sample liquid or diluent into the flash-filtration-bottle outer tube 2002, thereby realizing the transfer of the sample liquid or the diluent between different workstations. The movement route is convenient, so that the experimental efficiency can be improved and experimental errors can be reduced. In addition, integrating the sampling apparatus 300 on one side of the flash-filtration apparatus 100 greatly reduces the spatial volume of the experimental platform 1000, thereby realizing lightweight and miniaturization.

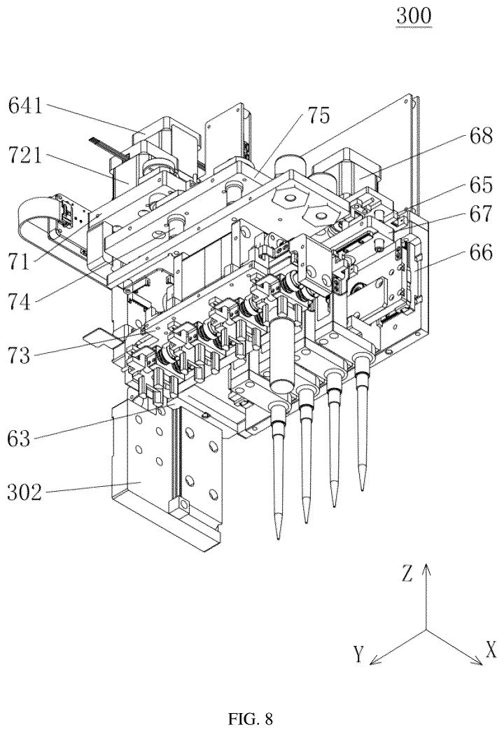

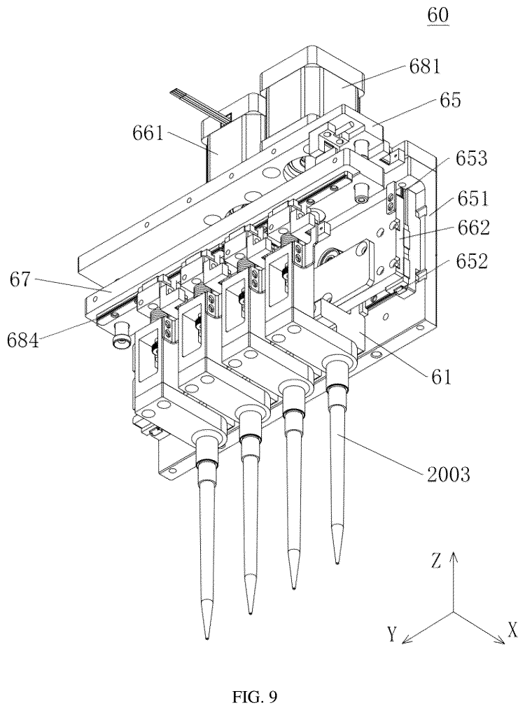

In an embodiment, as illustrated in FIG. 6, FIG. 8, and FIG. 9, the pipetting assembly 60 further includes a fourth sliding table 63 and a third lifting mechanism 64. The third lifting mechanism 64 is disposed on the third sliding table 302. The fourth sliding table 63 is slidably connected to the third sliding table 302 in the first direction Z. The pipette-tip mounting seat 61 is connected to the fourth sliding table 63. The third lifting mechanism 64 is connected to the fourth sliding table 63, and is configured to drive the fourth sliding table 63 to move in the first direction Z.

The shape of the fourth sliding table 63 may be block-shaped, plate-shaped, columnar, or other irregular shapes, etc., without limitation. Optionally, a guide rail is provided on a surface of the third sliding table 302 facing away from the side plate 15, and the fourth sliding table 63 is slidably connected to the guide rail.

Optionally, the pipette-tip mounting seat 61 is fixedly connected to the fourth sliding table 63, and the connection manner may be welding, bonding, snapping, screwing, riveting, etc., without limitation. Alternatively, the pipette-tip mounting seat 61 may also be movably connected to the fourth sliding table 63.

The third lifting mechanism 64 may be any feasible driving transmission structure in the art. Optionally, the third lifting mechanism 64 includes a third lifting driving member 641 and a third transmission rod (not shown). The third lifting driving member 641 is disposed on the third sliding table 302. The third transmission rod extends in the first direction Z and is in transmission connection with the third lifting driving member 641. Similarly, the third lifting driving member 641 may be a motor, an oil cylinder, an air cylinder, etc., without limitation. The third lifting driving member 641 may be configured to drive the third transmission rod to move in an axial direction of the third transmission rod. The third lifting driving member 641 has a drive shaft, and the drive shaft can move linearly when the third lifting driving member 641 is in operation. The connection manner between the third lifting driving member 641 and the third sliding table 302 may be welding, bonding, snapping, screwing, riveting, etc., without limitation.

Optionally, the third transmission rod rotates around an axis of the third transmission rod under the drive of the third lifting driving member 641, and is connected to the fourth sliding table 63 through a nut. The third transmission rod and the nut form a lead screw and nut pair, so that the rotational motion of the third transmission rod can be converted into the linear motion of the fourth sliding table 63, and the fourth sliding table 63 can move relative to the third sliding table 302 in the axial direction of the third transmission rod (i.e., the first direction Z) under the transmission connection of the third transmission rod.

The pipetting assembly 60 further includes the fourth sliding table 63 and the third lifting mechanism 64. The pipette-tip mounting seat 61 is connected to the fourth sliding table 63. The third lifting mechanism 64 is connected to the fourth sliding table 63 and can drive the fourth sliding table 63 to move in the first direction Z, thereby driving the pipette-tip mounting seat 61 to move in the first direction Z. The pipette tip 2003 can be mounted on the pipette-tip mounting seat 61. The pipette tip 2003 mounted on the pipette-tip mounting seat 61 can also move downward in the first direction Z, to extend into a test tube or other containers holding liquid to aspirate sample liquid or diluent. After aspiration, the pipette tip 2003 can move upward in the first direction Z to avoid interference with the test tube or other components. Similarly, when the pipette tip 2003 dispenses liquid into the flash-filtration-bottle outer tube 2002, the pipette tip 2003 can move downward in the first direction Z, and the liquid can be directly dispensed into the flash-filtration-bottle outer tube 2002. Therefore, the liquid can be prevented from being contaminated by impurities when dripping in the air or prevented from splashing outside the flash-filtration-bottle outer tube 2002, thereby reducing experimental errors during the experiment and improving the accuracy of the experiment.

In an embodiment, as illustrated in FIG. 8 to FIG. 10, the pipetting assembly 60 further includes a first mounting platform 65 and a spacing-adjusting mechanism 66. There are multiple pipette-tip mounting seats 61. The first mounting platform 65 is fixedly connected to the fourth sliding table 63. The multiple pipette-tip mounting seats 61 are all slidably connected to the first mounting platform 65 and can move in the third direction Y. The spacing-adjusting mechanism 66 is disposed on the first mounting platform 65 and is connected to the multiple pipette-tip mounting seats 61. The spacing-adjusting mechanism 66 is configured to drive the multiple pipette-tip mounting seats 61 to move in the third direction Y to adjust a distance between any two adjacent pipette-tip mounting seats 61.

The shape of the first mounting platform 65 may be block-shaped, plate-shaped, column-shaped, or other irregular shapes, etc., without limitation. The first mounting platform 65 and the fourth sliding table 63 may be connected and fixed by means of bonding, snapping, screwing, riveting, etc., without limitation.

The connection between the pipette-tip mounting seat 61 and the first mounting platform 65 may be direct or indirect, without limitation. Optionally, the pipetting assembly 60 further includes a mounting back plate 651. The mounting back plate 651 is fixedly connected to the first mounting platform 65 and is substantially perpendicular to the second direction X. The multiple pipette-tip mounting seats 61 are arranged on the mounting back plate 651 at intervals in the third direction Y and can move relative to the mounting back plate 651 in the third direction Y. In a specific embodiment, as illustrated in FIG. 9, there are four pipette-tip mounting seats 61.

The spacing-adjusting mechanism 66 can drive the multiple pipette-tip mounting seats 61 to move in the third direction Y. For pipette tips 2003 placed at different intervals, the pipetting assembly 60 can adaptively adjust the distance between any two adjacent pipette-tip mounting seats 61, thereby improving the adaptability of the pipetting assembly 60 and facilitating batch operations on the pipette tips 2003 to adapt to pipetting operations of containers with different intervals and sizes.

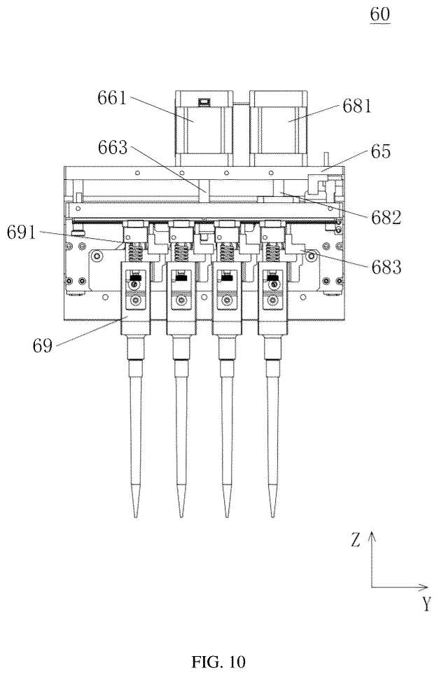

In an embodiment, as illustrated in FIG. 9 and FIG. 10, the spacing-adjusting mechanism 66 includes a spacing-adjusting driving member 661 and a spacing-adjusting plate 662. The spacing-adjusting driving member 661 is disposed on the first mounting platform 65. The spacing-adjusting plate 662 is in transmission connection with the spacing-adjusting driving member 661, and the multiple pipette-tip mounting seats 61 are all movably connected to the spacing-adjusting plate 662. The spacing-adjusting driving member 661 is configured to drive the spacing-adjusting plate 662 to move in the first direction Z, to drive the multiple pipette-tip mounting seats 61 to move in the third direction Y.

The spacing-adjusting driving member 661 may be a motor, an oil cylinder, an air cylinder, etc., without limitation. The connection manner between the spacing-adjusting driving member 661 and the first mounting platform 65 may be welding, bonding, snapping, screwing, riveting, etc., without limitation.

Optionally, the spacing-adjusting plate 662 is disposed on the mounting back plate 651 and may be slidably connected to the mounting back plate 651. A vertical rail 653 is provided on a surface of the mounting back plate 651 facing towards the spacing-adjusting plate 662. The spacing-adjusting plate 662 is slidably connected to the vertical rail 653. A first horizontal rail 652 is further provided on the surface of the mounting back plate 651 facing towards the spacing-adjusting plate 662. The pipette-tip mounting seat 61 passes through the spacing-adjusting plate 662 and is slidably connected to the first horizontal rail 652. The first horizontal rail 652 can increase the moving stability of the pipette-tip mounting seat 61. The vertical rail 653 can increase the moving stability of the spacing-adjusting plate 662.

Optionally, multiple slide grooves (not shown) extending in different directions are defined on the spacing-adjusting plate 662. The number of slide grooves corresponds to the number of pipette-tip mounting seats 61, and the pipette-tip mounting seats 61 and the slide grooves are arranged in a one-to-one correspondence. Optionally, the pipette-tip mounting seat 61 can move relative to the slide groove and move in an extending direction of the slide groove. For example, the multiple slide grooves may be distributed in a fan-shape, and the multiple slide grooves extend in a shape similar to fan ribs. In the first direction Z and from one end of the spacing-adjusting plate 662 close to the pipette tip 2003 to the other end of the spacing-adjusting plate 662 away from the pipette tip 2003, the distance between two adjacent slide grooves in the third direction Y may gradually decrease or gradually increase, without limitation. Alternatively, the slide grooves may also extend substantially in a zig-zag shape or an arc shape. The slide grooves on the spacing-adjusting plate 662 may also adopt any other feasible arrangement manners, as long as the distance between two adjacent slide grooves in the third direction Y changes when the spacing-adjusting plate 662 moves in the first direction Z, without specific limitation. With such an arrangement, during the movement of the spacing-adjusting plate 662 in the first direction Z, the multiple pipette-tip mounting seats 61 can move in the third direction Y under the limiting and guiding action of the slide grooves, so as to change the distance between two adjacent pipette-tip mounting seats 61.

Optionally, as illustrated in FIG. 9 and FIG. 10, the spacing-adjusting mechanism 66 further includes a spacing-adjusting transmission member 663. The spacing-adjusting transmission member 663 is in transmission connection with the spacing-adjusting driving member 661 and is connected to the spacing-adjusting plate 662. The spacing-adjusting transmission member 663 can drive the spacing-adjusting plate 662 to move in the first direction Z under the drive of the spacing-adjusting driving member 661, so as to drive the multiple pipette-tip mounting seats 61 to move in the third direction Y.

The spacing-adjusting transmission member 663 may adopt any feasible transmission structure in the art, such as a gear and rack pair or a lead screw and nut pair, without limitation.

By providing the above-mentioned spacing-adjusting mechanism 66, the distance between any two adjacent pipette-tip mounting seats 61 can be changed, thereby changing the distance between any two adjacent pipette tips 2003. Therefore, the adaptability of the pipetting assembly 60 can be improved, thereby facilitating the pipetting assembly 60 to perform batch operations on the pipette tips 2003, and meeting the requirements of high-throughput experimental processing.

In an embodiment, as illustrated in FIG. 8 to FIG. 10, the pipetting assembly 60 further includes a pressing plate 67, a pressing mechanism 68, and multiple separating members 69. The multiple separating members 69 are disposed on the pressing plate 67 and are slidably connected to the pressing plate 67. The multiple separating members 69 and the multiple pipette-tip mounting seats 61 are arranged in a one-to-one correspondence, and can move synchronously with the multiple pipette-tip mounting seats 61 in the third direction Y. The multiple separating members 69 can also move relative to the multiple pipette-tip mounting seats 61 in the first direction Z.

Optionally, the separating members 69 are disposed on a surface of the pressing plate 67 facing towards the pipette-tip mounting seat 61. A second horizontal rail 684 is provided on the surface of the pressing plate 67 facing towards the pipette-tip mounting seat 61. The separating members 69 are slidably connected to the second horizontal rail 684 and can move relative to the pressing plate 67 in the third direction Y. Optionally, the multiple separating members 69 are connected to the multiple pipette-tip mounting seats 61 in a one-to-one correspondence. Exemplarily, one end of the separating member 69 away from the pressing plate 67 may be sleeved on the pipette-tip mounting seat 61 and can move relative to the pipette-tip mounting seat 61 in the first direction Z. With such an arrangement, when the spacing-adjusting mechanism 66 drives the pipette-tip mounting seats 61 to move in the third direction Y, the separating members 69 can move synchronously with the pipette-tip mounting seats 61 in the third direction Y, thereby preventing the separating members 69 from failing to match the pipette-tip mounting seats 61 when the pressing plate 67 drives the separating members 69 to press down in the first direction Z.

Optionally, the separating member 69 is substantially in an “L” shape, including two ends protruding in the first direction Z and the second direction X respectively. The end of the separating member 69 protruding in the first direction Z extends towards the pressing plate 67 and is configured for sliding connection with the pressing plate 67. The end of the separating member 69 protruding in the second direction X extends towards the mounting back plate 651 in the second direction X, and is sleeved on one end of the pipette-tip mounting seat 61 away from the pressing plate 67. Optionally, the end of the separating member 69 protruding in the first direction Z is connected to the pressing plate 67 through a spring-buffer structure 691. Exemplarily, the separating member 69 includes a connecting section and a movable section. The spring-buffer structure 691 is arranged between the connecting section and the movable section. The connecting section and the movable section are movably connected through the spring-buffer structure 691. The connecting section is configured for sliding connection with the pressing plate 67. The movable section is configured for sleeving on the pipette-tip mounting seat 61. Optionally, the spring-buffer structure 691 may be a combination of a screw and a spring. One end of the screw is movably connected to the movable section, and the other end of the screw is fixedly connected to the connecting section. The spring is wound around the screw, and two ends of the spring elastically abut against the connecting section and the movable section respectively.

The pressing mechanism 68 is disposed on the first mounting platform 65 and is connected to the pressing plate 67. The pressing mechanism 68 is configured to drive the separating member 69 to move in the first direction Z to separate the pipette tip 2003 from the pipette-tip mounting seat 61.

The pressing mechanism 68 includes a pressing driving member 681 and a pressing transmission member 682. Optionally, the pressing driving member 681 may be a motor, an oil cylinder, an air cylinder, etc. The pressing transmission member 682 may adopt any feasible transmission structure in the art, without limitation. Optionally, the pressing driving member 681 may be a linear motor. The pressing transmission member 682 includes a lead screw and nut pair. The lead screw is connected to a drive shaft of the pressing driving member 681 through a coupling and extends in the first direction Z. The nut is connected to the pressing plate 67. The pressing driving member 681 can drive the lead screw to rotate, causing the nut to move linearly on the lead screw, thereby driving the pressing plate 67 to move in the first direction Z to drive the separating member 69 to move in the first direction Z.

When the pressing plate 67 is driven by the pressing mechanism 68 to press down, the separating member 69 is driven by the pressing plate 67 to move down in the first direction Z and presses against the pipette tip 2003 mounted at a tail end of the pipette-tip mounting seat 61, causing the pipette tip 2003 to fall off. When the pipette tip 2003 needs to be mounted on the pipette-tip mounting seat 61, the pipette-tip mounting seat 61 is driven by the third lifting mechanism 64 of the pipetting assembly 60 to move down, and the pipette tip 2003 moves up relative to the pipette-tip mounting seat 61 and presses against the separating member 69 at a tail end of the pipette-tip mounting seat 61. Since the spring-buffer structure 691 can deform and provide a movable space for the separating member 69 in the first direction Z, the separating member 69 moves up under the action of the spring-buffer structure 691 until the mounting of the pipette tip 2003 is completed.

Optionally, the pipetting assembly 60 is further provided with a pipette-tip recycling box for recycling pipette tips 2003 removed from the pipette-tip mounting seats 61.

Optionally, as illustrated in FIG. 10, the pipetting assembly 60 is further provided with a sensing element 683. The sensing element 683 may be disposed on the separating member 69. When the separating member 69 moves towards the pressing plate 67 in the first direction Z under the pressure of the pipette tip 2003 and the moving distance reaches a preset range, the sensing element 683 receives a signal, and the signal indicates that the pipette tip 2003 is mounted in place. Exemplarily, the sensing element 683 includes a sensor and a sensing piece. The sensor is disposed on the connecting section of the separating member 69, and the sensing piece is disposed on the movable section of the separating member 69. The sensor may be a photoelectric sensor. When the sensing piece is inserted into the sensor, it indicates that the pipette tip 2003 is mounted in place, and at this time, the downward movement of the pipette-tip mounting seat 61 can be stopped. With such an arrangement, the insufficient downward movement of the pipette-tip mounting seat 61, causing insecure mounting and poor sealing performance of the pipette tip 2003, can be prevented, and the damage to the pipette tip 2003 caused by the excessive downward movement of the pipette-tip mounting seat 61 can also be prevented.

By providing the above pipetting assembly 60, the used pipette tip 2003 can be separated from the pipette-tip mounting seat 61, and a new pipette tip 2003 can also be assisted in being mounted, thereby facilitating the replacement of the pipette tip 2003 on the pipette-tip mounting seat 61, with a simple structure. The separating members 69 can also adjust their positions according to the spacing between two adjacent pipette-tip mounting seats 61, thereby providing high adaptability and facilitating batch operations.

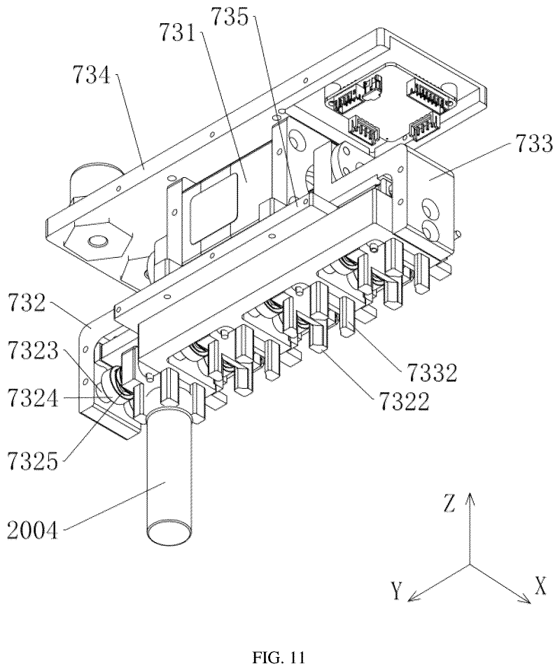

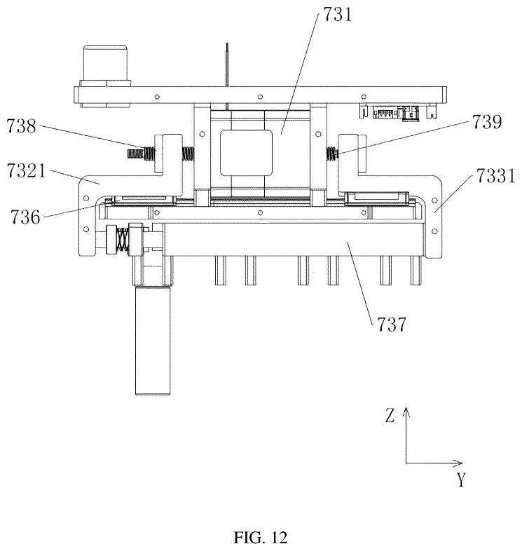

In an embodiment, as illustrated in FIG. 6 to FIG. 8, FIG. 11, and FIG. 12, the sampling apparatus 300 further includes a second clamping assembly 70. The second clamping assembly 70 is connected to the fourth sliding table 63 and is configured to clamp and move a test tube 2004. The test tube 2004 is configured for containing the sample liquid or the diluent. The second clamping assembly 70 is disposed on the fourth sliding table 63, so that the third lifting mechanism 64 can drive the second clamping assembly 70 and the pipette-tip mounting seat 61 to move synchronously in the first direction Z, thereby simplifying the driving manner and realizing a high degree of apparatus integration.

The second clamping assembly 70 includes a second mounting platform 71, a fourth lifting mechanism 72, and a second tube-clamping mechanism 73. The second mounting platform 71 is fixedly connected to the fourth sliding table 63. The fourth lifting mechanism 72 is disposed on the second mounting platform 71 and is connected to the second tube-clamping mechanism 73. The fourth lifting mechanism 72 is configured to drive the second tube-clamping mechanism 73 to move relative to the second mounting platform 71 in the first direction Z. The second tube-clamping mechanism 73 is configured to clamp the test tube 2004.

The shape of the second mounting platform 71 may be block-shaped, plate-shaped, column-shaped, or other irregular shapes, without limitation. Optionally, the second mounting platform 71 and the fourth sliding table 63 are connected and fixed by means of welding, bonding, snapping, screwing, riveting, etc., without limitation.

The fourth lifting mechanism 72 may be any feasible driving transmission structure in the art. Optionally, the fourth lifting mechanism 72 includes a fourth lifting driving member 721 and a fourth transmission rod (not shown). The fourth lifting driving member 721 is disposed on the second mounting platform 71. The fourth transmission rod extends in the first direction Z and is in transmission connection with the fourth lifting driving member 721.

Optionally, the fourth transmission rod is connected to the second tube-clamping mechanism 73, and the connection manner may be direct connection or indirect connection, without limitation. The fourth lifting driving member 721 can be configured to drive the fourth transmission rod to move along an axial direction of the fourth transmission rod. The fourth lifting driving member 721 has a drive shaft. When the fourth lifting driving member 721 operates, the drive shaft can move linearly to drive the second tube-clamping mechanism 73 to move in the first direction Z.

Optionally, the fourth transmission rod rotates around an axis of the fourth transmission rod under the drive of the fourth lifting driving member 721 and is connected to the second tube-clamping mechanism 73 through a nut. The fourth transmission rod and the nut form a lead screw and nut pair, so that the rotational motion of the fourth transmission rod can be converted into the linear motion of the second tube-clamping mechanism 73. The second tube-clamping mechanism 73 can move in the axial direction of the fourth transmission rod (i.e., the first direction Z) under the transmission connection of the fourth transmission rod.

The second clamping assembly 70 can transport the test tube 2004 to a designated workstation convenient for liquid aspiration by the pipetting assembly 60, thereby replacing manual transportation and meeting the needs of automated experiments. The fourth lifting mechanism 72 can drive the second tube-clamping mechanism 73 to move in the first direction Z, or the third lifting mechanism 64 can drive the second clamping assembly 70 to move in the first direction Z to realize the transfer of the test tube 2004. In addition, the fourth lifting mechanism 72 can drive the second tube-clamping mechanism 73 to move relative to the pipetting assembly 60 in the first direction Z, thereby preventing the second tube-clamping mechanism 73 from interfering with the pipetting assembly 60.

The test tube 2004 may be used to store a small amount of chemical substances or biological samples. The test tube 2004 may be a glass test tube 2004, a plastic test tube 2004, etc., according to actual needs, without limitation. The experimental platform 1000 in the embodiment of the present disclosure may adopt any feasible test tube 2004 in the art for operation, without limitation.

Optionally, the test tube 2004 includes a tube body and a cap. The tube body is used to hold sample liquid or diluent, and the cap is used to seal the tube body to prevent the liquid in the test tube 2004 from being contaminated by impurities in the external environment, thereby ensuring the purity of the liquid.

In an embodiment, as illustrated in FIG. 8, FIG. 11, and FIG. 12, the second tube-clamping mechanism 73 includes a second clamping driving member 731, a third clamping portion 732, and a fourth clamping portion 733. The second clamping driving member 731 is connected to the fourth lifting mechanism 72. At least one of the third clamping portion 732 or the fourth clamping portion 733 is connected to the second clamping driving member 731. The second clamping driving member 731 is configured to drive the third clamping portion 732 and the fourth clamping portion 733 to move relative to each other to clamp the test tube 2004.

Optionally, as illustrated in FIG. 11, the second tube-clamping mechanism 73 further includes a first fixed plate 734 and a second fixed plate 735. The first fixed plate 734 may be connected to the fourth lifting mechanism 72. The first fixed plate 734 and the second fixed plate 735 are arranged opposite to and spaced apart from each other in the first direction Z, and the first fixed plate 734 and the second fixed plate 735 are connected and fixed through a connecting member. The first fixed plate 734 is closer to the second mounting platform 71 than the second fixed plate 735. The second clamping driving member 731 is connected to the first fixed plate 734 and/or the second fixed plate 735, and the connection manner may be bonding, snapping, screwing, riveting, etc., without limitation. Optionally, at least one of the third clamping portion 732 or the fourth clamping portion 733 is slidably connected to the second fixed plate 735. To improve space utilization, the second clamping driving member 731 may be arranged between the first fixed plate 734 and the second fixed plate 735.

The third clamping portion 732 may be of an integrated structure made by an integral molding process, or the third clamping portion 732 may be of a split structure and various parts of the third clamping portion 732 may be connected and fixed by means of welding, bonding, snapping, screwing, riveting, etc., without limitation. Similarly, the structure of the fourth clamping portion 733 can refer to the aforementioned third clamping portion 732, and will not be repeated here.

Optionally, at least one of the third clamping portion 732 or the fourth clamping portion 733 is connected to the second clamping driving member 731 and can slide relative to the second fixed plate 735 under the drive of the second clamping driving member 731 to move relative to each other. When the third clamping portion 732 and the fourth clamping portion 733 move relative to each other, the third clamping portion 732 and the fourth clamping portion 733 may be used to clamp a single test tube 2004 or multiple test tubes 2004, without limitation.

Optionally, when the third clamping portion 732 and the fourth clamping portion 733 move towards each other, the second tube-clamping mechanism 73 clamps the test tube 2004, and when the third clamping portion 732 and the fourth clamping portion 733 move away from each other, the second tube-clamping mechanism 73 releases the test tube 2004. Alternatively, when the third clamping portion 732 and the fourth clamping portion 733 move away from each other, the second tube-clamping mechanism 73 clamps the test tube 2004, and when the third clamping portion 732 and the fourth clamping portion 733 move towards each other, the second tube-clamping mechanism 73 releases the test tube 2004, without limitation.

By providing the above-mentioned second tube-clamping mechanism 73, the test tube 2004 can be clamped and moved to a designated position, and the operation is simple.

In an embodiment, as illustrated in FIG. 11 and FIG. 12, the third clamping portion 732 includes a third mounting plate 7321 and multiple groups of third fingers 7322. The multiple groups of third fingers 7322 are arranged at intervals on the third mounting plate 7321. Each group of third fingers 7322 includes at least one third finger 7322. The fourth clamping portion 733 includes a fourth mounting plate 7331 and multiple groups of fourth fingers 7332. The multiple groups of fourth fingers 7332 are arranged at intervals on the fourth mounting plate 7331. Each group of fourth fingers 7332 includes at least one fourth finger 7332. The multiple groups of third fingers 7322 and the multiple groups of fourth fingers 7332 are arranged in a one-to-one correspondence. The third fingers 7322 and the fourth fingers 7332 are configured for relative movement to clamp the test tube 2004.

Optionally, the third clamping portion 732 and the fourth clamping portion 733 are configured for relative movement in the third direction Y.

At least one of the third mounting plate 7321 or the fourth mounting plate 7331 is connected to the second clamping driving member 731. Optionally, the third mounting plate 7321 and the fourth mounting plate 7331 are arranged at different sides of the second clamping driving member 731 in the third direction Y and are substantially symmetrically arranged, with the axis of symmetry extending in the first direction Z. Optionally, both the third mounting plate 7321 and the fourth mounting plate 7331 are substantially in a “Z” shape. The third mounting plate 7321 includes a fifth sub-plate, a sixth sub-plate, and a seventh sub-plate connected in sequence. The fifth sub-plate and the seventh sub-plate are substantially parallel to the first direction Z, and the sixth sub-plate is substantially perpendicular to the first direction Z (parallel to the third direction Y). Optionally, the fifth sub-plate is opposite to the second clamping driving member 731 in the third direction Y. The sixth sub-plate is slidably connected to the second fixed plate 735 through a slider 736. The seventh sub-plate is connected to the finger mounting member 737. The multiple groups of third fingers 7322 are arranged at intervals on the finger mounting member 737. The finger mounting member 737 may be a plate, a cylinder, a block, etc., without limitation.

The structure of the fourth mounting plate 7331 may be referred to the structure of the third mounting plate 7321, and will not be repeated here.

Optionally, the shape of the third finger 7322 is substantially columnar and extends in the first direction Z, so as to increase a contact area between the third finger 7322 and the test tube 2004 and improve the clamping stability. Multiple third fingers 7322 in each group of third fingers 7322 are arranged at intervals, spacing distances between the multiple groups of third fingers 7322 are substantially the same, and spacing distances between the multiple third fingers 7322 in each group of third fingers 7322 are also substantially the same. Optionally, the multiple third fingers 7322 in each group of third fingers 7322 may are connected as a whole through a connecting platform. In a specific implementation, there are four groups of third fingers 7322 arranged at intervals in the third direction Y, each group of third fingers 7322 includes two third fingers 7322, and the two third fingers 7322 are spaced apart from each other in the second direction X. It can be understood that the shape of the third finger 7322 may also be V-shaped, arc-shaped, etc., without limitation.

Similarly, the arrangement manner of the fourth fingers 7332 is similar to the arrangement manner of the third fingers 7322, which can be referred to and will not be repeated here.

In a specific embodiment, when the third finger 7322 and the fourth finger 7332 move towards each other, the second tube-clamping mechanism 73 clamps the test tube 2004, and when the third finger 7322 and the fourth finger 7332 move away from each other, the second tube-clamping mechanism 73 releases the test tube 2004. During operation, the second tube-clamping mechanism 73 is driven by the fourth lifting mechanism 72 to move in the first direction Z, and the third finger 7322 and the fourth finger 7332 are located at two sides of the test tube 2004. Then, the second clamping driving member 731 drives the third clamping portion 732 and the fourth clamping portion 733 to move relative to each other, to reduce a distance between the third finger 7322 and the fourth finger 7332 until both the third finger 7322 and the fourth finger 7332 abut against a tube wall of the test tube 2004, thereby completing the clamping action of the second tube-clamping mechanism 73. Subsequently, the second translation mechanism 301 drives the third sliding table 302 to move in the second direction X, so as to drive the second tube-clamping mechanism 73 to move in the second direction X until the test tube 2004 clamped between the third finger 7322 and the fourth finger 7332 moves to the designated workstation. At this time, the second tube-clamping mechanism 73 can be driven by the fourth lifting mechanism 72 to descend, to place the test tube 2004 at the designated workstation. After placement is completed, the second clamping driving member 731 drives the third clamping portion 732 and the fourth clamping portion 733 to move relative to each other, so that the third finger 7322 and the fourth finger 7332 move away from each other to release the test tube 2004, thereby completing the movement and placement of the test tube 2004.

By providing the above-mentioned second tube-clamping mechanism 73, the multiple test tubes 2004 can be clamped and moved simultaneously, with high experimental efficiency. In addition, moving distances of the multiple groups of third fingers 7322 and the multiple groups of fourth fingers 7332 are equal, so that there is no error in the moving distances, thereby improving the accuracy of batch operations.

In an embodiment, as illustrated in FIG. 11 and FIG. 12, the third clamping portion 732 further includes a mounting shaft 7323, limit rings 7324, and pre-tightening springs 7325. The mounting shaft 7323 is connected to the third mounting plate 7321 and extends in a moving direction of the third clamping portion 732. Each group of third fingers 7322 is slidably connected to the mounting shaft 7323. Each group of third fingers 7322 is provided with a limit ring 7324 at one side of the group of third fingers 7322 facing away from a corresponding fourth finger 7332. The limit rings 7324 are sleeved on the mounting shaft 7323 and fixedly connected to the mounting shaft 7323. Each group of third fingers 7322 and a corresponding limit ring 7324 is provided with a pre-tightening spring 7325 therebetween. One end of the pre-tightening spring 7325 is fixedly connected to the corresponding limit ring 7324, and the other end of the pre-tightening spring 7325 elastically abuts against the third finger 7322.

Optionally, the mounting shaft 7323 extends in the third direction Y, and one end of the mounting shaft 7323 is fixedly connected to the seventh sub-board. Optionally, the number of limit rings 7324 and the number of pre-tightening springs 7325 each are multiple, and each are equal to the number of groups of third fingers 7322. That is, each group of third fingers 7322 corresponds to one limit ring 7324 and one pre-tightening spring 7325. Optionally, the number of limit rings 7324 and the number of pre-tightening springs 7325 each are multiple, and each are equal to the number of third fingers 7322. That is, each third finger 7322 corresponds to one limit ring 7324 and one pre-tightening spring 7325. For example, when the third clamping portion 732 is provided with four groups of third fingers 7322, and each group of third fingers 7322 includes two third fingers 7322, there are eight limit rings 7324, eight pre-tightening springs 7325, and two mounting shafts 7323 arranged at intervals in the second direction X, and each mounting shaft 7323 is connected to four limit rings 7324 and four pre-tightening springs 7325.

The pre-tightening spring 7325 may be any feasible spring in the art, such as a compression spring, a tension spring, etc., without limitation. Optionally, the pre-tightening spring 7325 may be fixedly connected to or elastically abut against the limit ring 7324 and the third finger 7322, without limitation.

When the third clamping portion 732 and the fourth clamping portion 733 move relative to each other, the third finger 7322 and the fourth finger 7332 get closer to each other. At this time, the third finger 7322 and the fourth finger 7332 may be in contact with the side wall of the test tube 2004. When the third clamping portion 732 and the fourth clamping portion 733 continue to move relative to each other, the distance between the third finger 7322 and the fourth finger 7332 is further reduced, one end of the pre-tightening spring 7325 away from the limit ring 7324 elastically abuts against the third finger 7322, so as to generate a pre-tightening force on the third finger 7322. Therefore, the third finger 7322 can cooperate with the fourth finger 7332 to clamp the test tube 2004, so that not only can the test tube 2004 be prevented from falling off during handling, but also excessive force that would damage the test tube 2004 can be avoided.

By providing the above-mentioned third clamping portion 732, when the third clamping portion 732 and the fourth clamping portion 733 move relative to each other to clamp the test tube 2004, the pre-tightening spring 7325 can generate a pre-tightening force on the third finger 7322, thereby improving the clamping stability and safety of the second tube-clamping mechanism 73.

It can be understood that the structure of the fourth clamping portion 733 may be the same as, similar to, or different from the structure of the third clamping portion 732, without limitation. For example, on the basis that the fourth clamping portion 733 includes the above-mentioned fourth mounting plate 7331 and the multiple groups of fourth fingers 7332, the fourth clamping portion 733 may further include a finger mounting member 737. The finger mounting member 737 is fixedly connected to the fourth mounting plate 7331, and the multiple groups of fourth fingers 7332 arranged at equal intervals are fixedly connected to the finger mounting member 737. The finger mounting member 737 may be plate-shaped, strip-shaped, etc., without limitation.

In an embodiment, as illustrated in FIG. 12, the second tube-clamping mechanism 73 further includes a third transmission member 738 and a fourth transmission member 739. The second clamping driving member 731 is connected to each of the third transmission member 738 and the fourth transmission member 739. The third transmission member 738 is connected to the third clamping portion 732. The fourth transmission member 739 is connected to the fourth clamping portion 733. The second clamping driving member 731 is configured to drive the third transmission member 738 and the fourth transmission member 739 to move in opposite directions.

The third transmission member 738 and the third clamping portion 732 may be connected and fixed by means of welding, bonding, snapping, screwing, riveting, etc., without limitation. Optionally, the third transmission member 738 is connected to a surface of the third mounting plate 7321 facing away from the third finger 7322. Optionally, the second clamping driving member 731 is configured to drive the third transmission member 738 to move or rotate, to drive the third clamping portion 732 to move. The connection manner between the fourth transmission member 739 and the fourth clamping portion 733 can refer to the connection manner between the third transmission member 738 and the third clamping portion 732, without specific limitation.

Optionally, at least one of the third transmission member 738 or the fourth transmission member 739 may be a single rack, a rack set formed by multiple engaged racks, or a rack in combination with other transmission structures (such as gears), without specific limitation. In a specific embodiment, the second clamping driving member 731 is a motor, and the second tube-clamping mechanism 73 further includes a gear. The transmission gear is connected to the second clamping driving member 731 and rotates under the drive of the second clamping driving member 731. Both the third transmission member 738 and the fourth transmission member 739 are racks and are engaged with the gear respectively. When the second clamping driving member 731 drives the gear to rotate, the third transmission member 738 and the fourth transmission member 739 respectively drive the third clamping portion 732 and the fourth clamping portion 733 to move in opposite directions to clamp or release the test tube 2004.

In another implementation, as illustrated in FIG. 12, the second clamping driving member 731 is a linear motor, and each of the third transmission member 738 and the fourth transmission member 739 includes a lead screw and nut pair. Specifically, the lead screw of the third transmission member 738 and the lead screw of the fourth transmission member 739 are both connected to a drive shaft of the second clamping driving member 731. The nut of the third transmission member 738 is connected to the third clamping portion 732, and the nut of the fourth transmission member 739 is connected to the fourth clamping portion 733. When the drive shaft of the second clamping driving member 731 rotates, the lead screw of the third transmission member 738 and the lead screw of the fourth transmission member 739 rotate in opposite directions, or the nut of the third transmission member 738 and the nut of the fourth transmission member 739 move in opposite directions in the respective lead screw respectively, thereby driving the third clamping portion 732 and the fourth clamping portion 733 to move relative to each other to clamp or release the test tube 2004.

The second tube-clamping mechanism 73 further includes the third transmission member 738 and the fourth transmission member 739. The second clamping driving member 731 is configured to drive the third transmission member 738 and the fourth transmission member 739 to move in opposite directions and drive the third clamping portion 732 and the fourth clamping portion 733 to move relative to each other. Therefore, the transmission manner is simple and reliable.

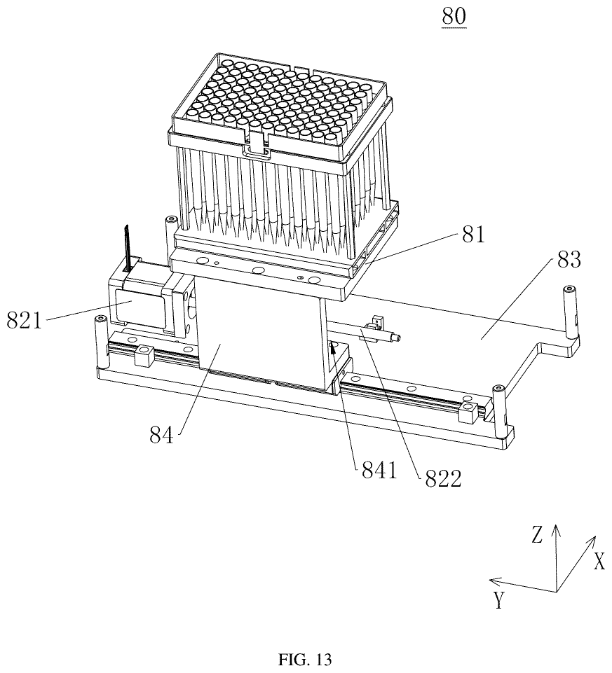

In an embodiment, as illustrated in FIG. 7 and FIG. 13, the sampling apparatus 300 further includes a pipette-tip tray assembly 80. The pipette-tip tray assembly 80 includes a pipette-tip tray placement seat 81 and a second moving mechanism. The pipette-tip tray placement seat 81 is slidably connected to the base 200 and movable in the second direction X and/or the third direction Y. The second moving mechanism is disposed on the base 200 and connected to the pipette-tip tray placement seat 81. The second moving mechanism is configured to drive the pipette-tip tray placement seat 81 to move relative to the base 200. The pipette-tip tray placement seat 81 is configured for placement of a pipette tip 2003.

The pipette-tip tray placement seat 81 is configured for placement of the pipette-tip tray, and the pipette-tip tray is configured for accommodation of multiple pipette tips 2003, thereby facilitating batch operations on the multiple pipette tips 2003. The pipette-tip tray placement seat 81 may be substantially rectangular, square, trapezoidal, etc. The shape of the pipette-tip tray placement seat 81 only needs to correspond to the shape of the pipette-tip tray, without specific limitation.

Optionally, the pipette-tip tray placement seat 81 is configured for placement of a single pipette-tip tray, and the multiple pipette tips 2003 may be distributed in an array of multiple rows and columns within the pipette-tip tray. Alternatively, the pipette-tip tray placement seat 81 is configured for placement of the multiple pipette-tip trays, and at least one pipette tip 2003 is placed on each of the multiple pipette-tip trays, without limitation.

Optionally, the second moving mechanism may be directly disposed on the base 200. Alternatively, as illustrated in FIG. 13, the pipette-tip tray assembly 80 further includes a fixed seat 83. The fixed seat 83 is mounted on the base 200. The second moving mechanism is disposed on the fixed seat 83 and connected to the pipette-tip tray placement seat 81.

The second moving mechanism may be any feasible driving transmission structure in the art. Optionally, the second moving mechanism includes a second moving driving member 821. The second moving driving member 821 is disposed on the fixed seat 83. The second moving driving member 821 may be a motor, an oil cylinder, an air cylinder, etc., without limitation.

Optionally, the pipette-tip tray placement seat 81 can move relative to the fixed seat 83 in the third direction Y. The second moving driving member 821 may be a linear motor. The second moving mechanism further includes a fourth transmission portion 822. The fourth transmission portion 822 includes a lead screw and nut pair. The lead screw is connected to a drive shaft of the second moving driving member 821 through a coupling, and the nut is connected to the pipette-tip tray placement seat 81. Optionally, the lead screw of the second transmission portion 522 extends in the third direction Y. The second moving driving member 821 is configured to drive the lead screw to rotate, causing the nut to move linearly on the lead screw, thereby driving the pipette-tip tray placement seat 81 to move on the fixed seat 83 in the third direction Y.

Optionally, when the pipette tip 2003 needs to be mounted on the pipetting assembly 60, the pipette-tip tray placement seat 81 can move in the third direction Y to below the pipetting assembly 60. That is, in the first direction Z, an orthographic projection of at least part of the pipette-tip tray placement seat 81 overlaps an orthographic projection of the pipetting assembly 60, thereby facilitating the pipette tip 2003 to be mounted on the pipette-tip mounting seat 61.

By providing the above-mentioned pipette-tip tray assembly 80, the loading and unloading of a whole tray of pipette tips 2003 can be carried out, thereby facilitating the batch experimental operations of the pipetting assembly 60, improving the experimental efficiency, and meeting the requirements of high-throughput experimental processing.

In an embodiment, as illustrated in FIG. 13, the pipette-tip tray assembly 80 further includes a pipette-tip mounting frame 84. The pipette-tip mounting frame 84 is connected to the second moving mechanism. The pipette-tip tray placement seat 81 is disposed on the pipette-tip mounting frame 84. The pipette-tip mounting frame 84 and the base 200 define an avoidance space 841 therebetween. The avoidance space 841 allows for accommodation of at least part of the flash-filtration-bottle tray placement seat 51.

The pipette-tip tray placement seat 81 and the pipette-tip mounting frame 84 may be of an integrated structure. Alternatively, the pipette-tip tray placement seat 81 and the pipette-tip mounting frame 84 may be of a split structure, and the pipette-tip tray placement seat 81 and the pipette-tip mounting frame 84 may be connected and fixed by means of welding, bonding, snapping, screwing, riveting, etc., without limitation.

Optionally, the pipette-tip mounting frame 84 is roughly in a “C” shape, and includes a first sub-part and a second sub-part that are opposite to and spaced apart from each other in the first direction Z, and a third sub-part connected between the first sub-part and the second sub-part. The first sub-part is slidably connected to the fixed seat. The pipette-tip tray placement seat 81 is placed on a surface of the second sub-part facing away from the first sub-part. The first sub-part, the second sub-part, and the third sub-part cooperatively define the avoidance space 841 directly. Optionally, the pipette-tip mounting frame 84 is substantially in an “L” shape, and the combination of the pipette-tip mounting frame 84 and the pipette-tip tray placement seat 81 may be substantially in a “C” shape.

Optionally, with reference to the arrangement of the aforementioned flash-filtration-bottle tray placement seat 51, when both the flash-filtration-bottle tray placement seat 51 and the pipette-tip tray placement seat 81 are located at the pipetting workstation, as illustrated in FIG. 6 and FIG. 7, the first tray-placement-seat 511 and the pipette-tip tray placement seat 81 are substantially on the same straight line in the second direction X, thereby facilitating the movement of the pipetting assembly 60 between the first tray-placement-seat 511 and the pipette-tip tray. At this time, in the first direction Z, an orthographic projection of at least part of the second tray-placement-seat 512 overlaps an orthographic projection of the pipette-tip tray placement seat 81, that is, at least part of the second tray-placement-seat 512 is accommodated in the avoidance space 841. Exemplarily, the first tray-placement-seat 511 is configured for placement of a flash-filtration-bottle outer-tube tray, the second tray-placement-seat 512 is configured for placement of a flash-filtration-bottle inner-tube tray, and the second tray-placement-seat 512 and the flash-filtration-bottle inner-tube tray can be accommodated in the avoidance space 841.

With such an arrangement, there is no need to define an additional avoidance space for the second tray-placement-seat 512 on the moving path of the flash-filtration-bottle tray placement seat 51 in the third direction Y, thereby reducing the overall volume of the experimental platform 1000, improving the space utilization rate, avoiding interference between different components, and setting a moving line between different workstations reasonably.

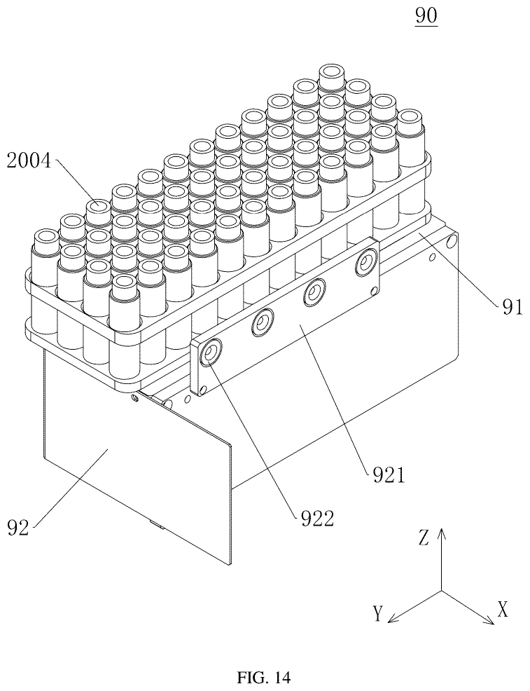

In an embodiment, as illustrated in FIG. 6 and FIG. 14, the sampling apparatus 300 further includes a test-tube rack assembly 90. The test-tube rack assembly 90 includes a test-tube rack placement seat 91 and a test-tube mounting frame 92. The test-tube mounting frame 92 is mounted on the base 200. The test-tube rack placement seat 91 is disposed on the test-tube mounting frame 92. The test-tube rack placement seat 91 is configured for placement of the test tube 2004.

The test-tube mounting frame 92 and the base 200 may be of an integrated structure. Alternatively, the test-tube mounting frame 92 and the base 200 may be of a split structure. The test-tube mounting frame 92 and the base 200 may be connected and fixed by means of welding, bonding, snapping, screwing, riveting, etc., without limitation.

The test-tube rack placement seat 91 is configured for placement of the test-tube rack, and the test-tube rack contains multiple test tubes 2004, thereby facilitating the batch operation of the multiple test tubes 2004. The test-tube rack placement seat 91 may be substantially rectangular, square, trapezoidal, etc. The shape of the test-tube rack placement seat 91 only needs to correspond to the shape of the test-tube rack, and there is no specific limitation.

Optionally, the test-tube rack placement seat 91 is configured for placement of a single test-tube rack, and the multiple test tubes 2004 may be distributed in an array of multiple rows and columns within the test-tube rack. Alternatively, the test-tube rack placement seat 91 is configured for placement of multiple test-tube racks, and each test-tube rack contains at least one test tube 2004, without limitation.

The test-tube mounting frame 92 is spaced apart from the flash-filtration apparatus 100 in the third direction Y and is spaced apart from the pipette-tip tray assembly 80 in the second direction X.

Optionally, the test-tube rack placement seat 91 may be fixedly connected to the test-tube mounting frame 92 or movably connected to the test-tube mounting frame 92, without limitation. In a specific embodiment, the test-tube rack assembly 90 further includes a third moving mechanism (not shown). The third moving mechanism is disposed on the test-tube mounting frame 92 and connected to the test-tube rack placement seat 91. The third moving mechanism can drive the test-tube rack placement seat 91 to slide relative to the test-tube mounting frame 92 in the second direction X and/or the third direction Y. Exemplarily, when the test-tube rack placement seat 91 moves relative to the test-tube mounting frame 92 in the second direction X, the test-tube rack placement seat 91 can extend from the base 200, thereby facilitating the loading and unloading of test tubes 2004. When the test-tube rack placement seat 91 moves relative to the test-tube mounting frame 92 in the third direction Y, after the second clamping assembly 70 transfers a group of test tubes 2004, the position of the next group of test tubes 2004 can be adjusted in time, thereby facilitating the second clamping assembly 70 to grip, or after the pipetting assembly 60 aspirates liquid from a group of test tubes 2004, the position of the next group of test tubes 2004 can be adjusted in time, thereby facilitating the pipetting assembly 60 to perform the next pipetting operation and realizing the high flexibility.

The third moving mechanism may adopt any feasible transmission structure in the art, without limitation. Optionally, the arrangement of the third moving mechanism can refer to the aforementioned second moving mechanism, and will not be repeated here.

By providing the test-tube rack assembly 90, and the test-tube rack placement seat 91 is configured for placement of the test tubes 2004, so that the loading and unloading of a whole rack of test tubes 2004 can be realized, thereby facilitating the batch experimental operations of the sampling apparatus 300, improving the experimental efficiency, and meeting the requirements of high-throughput experimental processing.

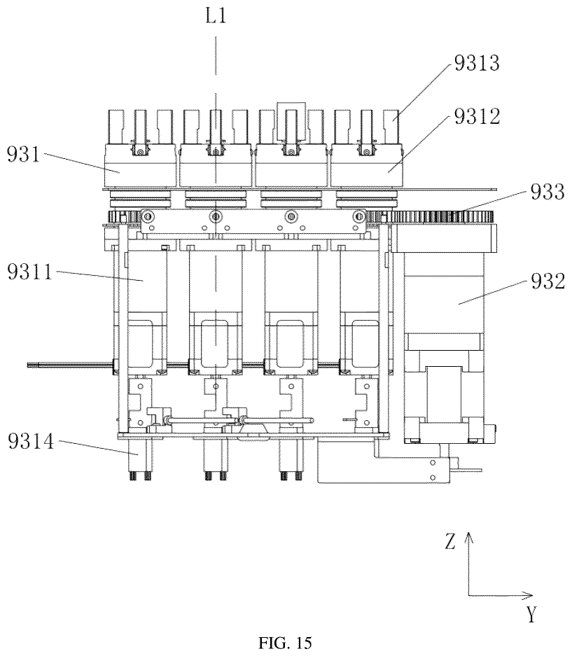

In an embodiment, as illustrated in FIG. 7 and FIG. 15, the sampling apparatus 300 further includes a third clamping assembly 93. The third clamping assembly 93 is disposed close to the test-tube rack assembly 90, thereby helping to shorten the transfer time of the test tube 2004. The third clamping assembly 93 is configured to open or close a cap of the test tube 2004.

The third clamping assembly 93 includes a third tube-clamping mechanism 931. The third tube-clamping mechanism 931 is configured to clamp a tube body of the test tube 2004 and rotate around a first axis L1. The third tube-clamping mechanism 931 is configured to cooperate with the second tube-clamping mechanism 73 to open or close the test tube 2004. The first axis L1 coincides with an axis of the test tube 2004. Optionally, the first axis L1 extends in the first direction Z.

Optionally, the third clamping assembly 93 further includes a gripper support frame 94. The gripper support frame 94 is mounted on the base 200 and located between the test-tube rack assembly 90 and the pipette-tip tray assembly 80. The third tube-clamping mechanism 931 is disposed on the gripper support frame 94. The gripper support frame 94 and the base 200 may be of an integrated structure. Alternatively, the gripper support frame 94 and the base 200 may be of a split structure, and the gripper support frame 94 and the base 200 may be connected and fixed by means of welding, bonding, snapping, screwing, riveting, etc., without limitation. Optionally, the gripper support frame 94 and the test-tube mounting frame 92 may also be of an integrated structure.

Optionally, the third tube-clamping mechanism 931 is substantially centrosymmetric along the first axis L1. With such an arrangement, the weight distribution of the third tube-clamping mechanism 931 is relatively uniform, and during the rotation around the first axis L1 of the third clamping mechanism 931, the center of gravity of the third clamping mechanism 931 is not easy to shift, thereby enabling a long service life. The third tube-clamping mechanism 931 also provides stable clamping of the test tube 2004, and the tube body of the test tube 2004 is not easy to tilt.

The test tubes 2004 placed in the test-tube rack assembly 90 are in a closed state, that is, the tube body and the cap of the test tube 2004 are buckled together at this time, thereby preventing the sample liquid in the test tube 2004 from being contaminated by the external environment. Therefore, before the pipette tip 2003 aspirates the sample liquid from the test tube 2004, the cap of the test tube 2004 needs to be opened manually or mechanically, so as to facilitate the pipetting operation of the pipette tip 2003. The third clamping assembly 93 is disposed at a cap-opening workstation. The second tube-clamping mechanism 73 of the second clamping assembly 70 can clamp the cap of the test tube 2004 from the test-tube rack assembly 90 and moves the test tube 2004 above the third tube-clamping mechanism 931. The third tube-clamping mechanism 931 can clamp the tube body of the test tube 2004 and cooperate with the second tube-clamping mechanism 73. The second tube-clamping mechanism 73 can clamp the cap of the test tube 2004 and remains stationary, the third tube-clamping mechanism 931 can clamp the tube body of the test tube 2004 and rotates around the axis of the test tube, and a relative rotation occurs between the tube body and the cap of the test tube 2004, so that the cap is detached from the tube body, thereby facilitating the pipette tip 2003 to extend into the test tube 2004 to aspirate the sample liquid. After the pipette tip 2003 completes the liquid aspiration, the second tube-clamping mechanism 73 and the third tube-clamping mechanism 931 can screw the tube body and the cap of the test tube 2004 tightly in a similar way, so as to prevent the sample liquid in the test tube 2004 from spilling and contaminating the experimental platform 1000. It can be understood that the third tube-clamping mechanism 931 may clamp the tube body of the test tube 2004 and remain stationary, while the second tube-clamping mechanism 73 clamps the cap of the test tube 2004 and rotates the cap of the test tube 2004, which is not limited here.

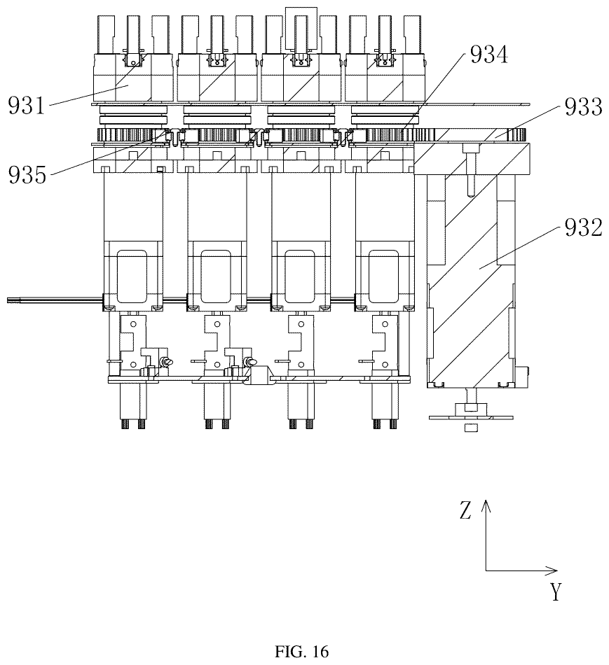

In an embodiment, as illustrated in FIG. 15 and FIG. 16, the third tube-clamping mechanism 931 includes a third clamping driving member 9311, a finger mounting seat 9312, and multiple fifth fingers 9313. The third clamping driving member 9311 is disposed on the finger mounting seat 9312. The multiple fifth fingers 9313 are disposed at intervals in a circumferential direction of the finger mounting seat 9312. The third clamping driving member 9311 is connected to the multiple fifth fingers 9313 and is configured to drive the multiple fifth fingers 9313 to move in a radial direction of the finger mounting seat 9312 to clamp the tube body of the test tube 2004.

The third clamping driving member 9311 may be a motor, an oil cylinder, an air cylinder, etc., without limitation. Optionally, the third clamping driving member 9311 is disposed on one end of the finger mounting seat 9312 facing away from the fifth finger 9313. The connection manner between the third clamping driving member 9311 and the finger mounting seat 9312 may be welding, bonding, snapping, screwing, riveting, etc., without limitation.

Optionally, an electrical slip ring 9314 is provided at one end of the third clamping driving member 9311 away from the finger mounting seat 9312. The electrical slip ring 9314 is configured to transmit electric energy to the third clamping driving member 9311.

Optionally, in the first direction Z, the shape of the orthographic projection of the finger mounting seat 9312 may be substantially circular, regular polygonal, etc., without limitation. The shape of the fifth finger 9313 may be strip-shaped, sheet-shaped, columnar, block-shaped, claw-shaped, etc., without limitation. The number of the fifth fingers 9313 is not limited, and specifically may be three, four, five, etc. Optionally, the multiple fifth fingers 9313 are all slidably connected to the finger mounting seat 9312 and are substantially centrally symmetrical along the first axis L1.

Optionally, the third clamping driving member 9311 may be connected to the fifth finger 9313 through any feasible transmission structure in the art. The second tube-clamping mechanism 73 can clamp the cap of the test tube 2004 and move the test tube 2004 above the third tube-clamping mechanism 931, and at least part of the tube body of the test tube 2004 extends between the multiple fifth fingers 9313 of the third tube-clamping mechanism 931. At this time, the multiple fifth fingers 9313 move in the radial direction of the finger mounting seat 9312 towards the test tube 2004 and abut against the outer wall of the test tube 2004 to clamp the tube body of the test tube 2004. When removing the test tube 2004, the multiple fifth fingers 9313 first move away from the test tube 2004 in the radial direction of the finger mounting seat 9312 under the drive of the third clamping driving member 9311, and then the second tube-clamping mechanism 73 clamps the cap of the test tube 2004 and drives the test tube 2004 to move upward to remove the test tube 2004.

By providing the above-mentioned third tube-clamping mechanism 931, the transmission manner is simple and efficient.

In an embodiment, as illustrated in FIG. 15 and FIG. 16, there are multiple third tube-clamping mechanisms 931. The third clamping assembly 93 further includes a rotary driving member 932, a first gear 933, and second gears 934. The rotary driving member 932 is connected to the first gear 933. Each third tube-clamping mechanism 931 is connected to a second gear 934, and the second gear 934 is coaxial with the third tube-clamping mechanism 931. The first gear 933 is engaged with one of the second gears 934. Two adjacent second gears 934 are engaged with each other. The rotary driving member 932 is configured to drive the first gear 933 to rotate to drive the multiple third tube-clamping mechanisms 931 to synchronously rotate around the first axis L1 through the second gears 934.

The number of the third tube-clamping mechanisms 931 is equal to the number of groups of the fourth fingers 7332 (or the third fingers 7322) in the second tube-clamping mechanism 73. An arrangement direction of the multiple third tube-clamping mechanisms 931 is the same as an arrangement direction of the multiple groups of fourth fingers 7332, and a distance between two adjacent third tube-clamping mechanisms 931 is equal to a distance between two adjacent groups of fourth fingers 7332. Exemplarily, the multiple groups of fourth fingers 7332 are arranged at intervals in the third direction Y, the multiple third tube-clamping mechanisms 931 are arranged at intervals in the third direction Y on the gripper support frame 94, and the distance between two adjacent third tube-clamping mechanisms 931 is equal to the distance between two adjacent groups of fourth fingers 7332, thereby facilitating batch operation.

Optionally, the rotary driving member 932 is disposed on the gripper support frame 94. The rotary driving member 932 may be a motor, an oil cylinder, an air cylinder, etc., without limitation. Optionally, the rotary driving member 932 is a motor. A drive shaft of the rotary driving member 932 is connected to the first gear 933 and can drive the first gear 933 to rotate.

Optionally, the second gear 934 is sleeved on the finger mounting seat 9312 of the third tube-clamping mechanism 931. Optionally, a second gear 934 sleeved on one of the outermost third tube-clamping mechanisms 931 among the multiple third tube-clamping mechanisms 931 is engaged with the first gear 933, so that the power of the rotary driving member 932 can be transferred to the third tube-clamping mechanism 931.

Optionally, the third clamping assembly 93 further includes third gears 935. Two adjacent second gears 934 are engaged with each other through a third gear 935. That is, all the second gears 934 connected to the third tube-clamping mechanisms 931 are directly or directly engaged with the first gear 933. Therefore, all the third tube-clamping mechanisms 931 can be driven to rotate simultaneously by one rotary driving member 932, and the transmission manner is simple and efficient.

Optionally, the modules of the first gear 933, the second gear 934, and the third gear 935 may be the same or different, without limitation.

Any other feasible transmission structure may also be adopted to connect the rotary driving member 932 and the third tube-clamping mechanism 931, without specific limitation.

By providing the above-mentioned third clamping assembly 93, the caps of the test tubes 2004 can be opened and closed in batches, so that the transmission manner is simple and efficient, and the experimental throughput is high.

In an embodiment, as illustrated in FIG. 14 and FIG. 15, the test-tube mounting frame 92 is provided with a magnet mounting plate 921 at one side of the test-tube mounting frame 92 close to the third clamping assembly 93. The magnet mounting plate 921 extends in an arrangement direction of the multiple third tube-clamping mechanisms 931. The magnet mounting plate 921 is provided with multiple magnets 922 arranged at intervals. The multiple magnets 922 and the multiple third tube-clamping mechanisms 931 are arranged in a one-to-one correspondence.

Optionally, the magnet mounting plate 921 and the test-tube mounting frame 92 may be of an integrated structure or a split structure. The magnet mounting plate 921 and the test-tube mounting frame 92 are connected and fixed by means of welding, bonding, snapping, screwing, riveting, etc., without limitation.

Optionally, the magnets 922 are disposed on a surface of the magnet mounting plate 921 facing away from the test-tube rack placement seat 91, so as to avoid interference with the test tubes 2004 in the test-tube rack. The magnets 922 may be fixedly connected to the magnet mounting plate 921 by means of bonding, snapping, etc., without limitation.

The magnet 922 is used to attract a magnetic bead in the test tube 2004. Optionally, the test tube 2004 in the test-tube rack placement seat 91 needs to undergo magnetic stirring in the preceding process before entering the experimental platform 1000, so the magnetic bead is placed in the test tube 2004. To prevent the magnetic bead from affecting the insertion of the pipette tip 2003 into the test tube 2004 and the aspiration of the sample liquid (or other liquids), the magnetic bead can be attracted to one side of the test tube 2004 by the magnet 922 on the magnet mounting plate 921. In addition, when the cap of the test tube 2004 needs to be opened before aspirating the sample liquid, the magnetic bead in the test tube 2004 is attracted to one side of the magnet mounting plate 921 by the magnet 922 and remains stationary, while the tube body of the test tube 2004 drives the sample liquid inside to rotate. The magnetic bead can play a role in stirring the sample, thereby further homogenizing the sample liquid.

In an embodiment, as illustrated in FIG. 8, the second clamping assembly 70 further includes a buffering mechanism 74 and a third mounting platform 75. The third mounting platform 75 is connected to the fourth lifting mechanism 72. The buffering mechanism 74 is disposed between the third mounting platform 75 and the second tube-clamping mechanism 73, and is configured for movement of the second tube-clamping mechanism 73 relative to the third mounting platform 75 in the first direction Z.

Optionally, the buffering mechanism 74 includes a guide post and an elastic member. The guide post extends in the first direction Z. One of the third mounting platform 75 and the second tube-clamping mechanism 73 (such as the first fixed plate 734) is fixedly connected to the guide post, and the other of the third mounting platform 75 and the second tube-clamping mechanism 73 is movably connected to the guide post. The elastic member is disposed around the guide post. One end of the elastic member elastically abuts against a surface of the third mounting platform 75 facing towards the second tube-clamping mechanism 73, and the other end of the elastic member elastically abuts against the second tube-clamping mechanism 73 in the first direction Z. It can be understood that the elastic member may be a spring, a rubber block, a rubber sleeve, a leaf spring, etc. The guide post may be a bolt, a screw, etc. Optionally, the buffering mechanism 74 may only include an elastic member (such as a spring). One end of the elastic member is fixedly connected to the third mounting platform 75, and the other end of the elastic member is fixedly connected to the second tube-clamping mechanism 73.

When there is no relative movement between the second tube-clamping mechanism 73 and the third mounting platform 75, the buffering mechanism 74 may have an initial deformation or no deformation. During capping, in the process of screwing the cap of the test tube 2004 onto the tube body, the cap of the test tube 2004 may pull the second tube-clamping mechanism 73 to move downward, so that the buffering mechanism 74 may change from the initial deformation to a larger deformation, or from no deformation to some deformation. During opening the cap, in the process of unscrewing the cap of the test tube 2004 from the tube body, the cap of the test tube 2004 may press the second tube-clamping mechanism 73 to move upward, so that the buffering mechanism 74 may change from the initial deformation to a smaller deformation. The elastic deformation of the buffering mechanism 74 provides a buffering force for the second tube-clamping mechanism 73 in the first direction Z, so as to assist in opening and closing the cap of the test tube 2004, thereby improving the accuracy and success rate of opening and closing the cap.

It can be understood that the buffering mechanism 74 may also be disposed on the third clamping assembly 93, without limitation.

Optionally, as illustrated in FIG. 6 and FIG. 7, in the second direction X, the test-tube rack assembly 90, the third clamping assembly 93, the pipette-tip tray assembly 80, and the flash-filtration-bottle transfer assembly 50 are arranged in sequence. With such an arrangement, it is convenient to sequentially perform experimental procedures such as loading, cap-opening, pipetting, and filtration, thereby saving experimental interaction time and providing a reasonable structural layout.

A specific workflow of the experimental platform 1000 in the embodiments of the present disclosure is described below.

The test-tube rack containing sample liquid is moved to the test-tube rack placement seat 91 manually or by a robot. Then, manually or by a robot, the flash-filtration-bottle inner-tube tray loaded with the flash-filtration-bottle inner tubes 2001, the flash-filtration-bottle outer-tube tray loaded with the flash-filtration-bottle outer tubes 2002, and the pipette-tip tray loaded with pipette tips 2003 are moved to the corresponding tray placement positions on the experimental platform 1000, thereby completing the pre-experiment loading.

Then, the second tube-clamping mechanism 73 of the sampling apparatus 300 clamps the cap of the test tube 2004 from the test-tube rack and moves the test tube 2004 to the cap-opening workstation. The third tube-clamping mechanism 931 at the cap-opening workstation clamps the tube body of the test tube 2004 and cooperates with the second tube-clamping mechanism 73 to open the test tube 2004. At this time, the flash-filtration-bottle outer-tube tray and the flash-filtration-bottle inner-tube tray are located at the pipetting workstation. The pipetting assembly 60 moves to the pipette-tip tray to mount pipette tips 2003 in batches, then moves above the test tubes 2004 and extends into the test tubes 2004 to aspirate and dispense the sample liquid for mixing. After mixing is completed, the pipette tip 2003 aspirates a certain amount of sample liquid from the test tube 2004, moves above the flash-filtration-bottle outer tube 2002, and transfers the certain amount of sample liquid into the flash-filtration-bottle outer tube 2002. After the transfer is completed, the pressing plate 67 of the pipetting assembly 60 drives the separating member 69 to press down and separate the used pipette tips 2003 from the pipetting assembly 60 to complete the sampling.

After that, the second tube-clamping mechanism 73 moves to the cap-opening workstation and cooperates with the third tube-clamping mechanism 931 to close the cap of the test tube 2004. After the cap is closed, the second tube-clamping mechanism 73 clamps the test tube 2004 and moves the test tube 2004 to the test-tube rack, returning the test tube 2004 to its original slot. At the same time, the flash-filtration-bottle transfer assembly 50 drives the flash-filtration-bottle outer-tube tray and the flash-filtration-bottle inner-tube tray to move to the flash-filtration workstation. The liquid-dispensing assembly 40 of the flash-filtration apparatus 100 moves above the flash-filtration-bottle outer tube 2002 and dispenses the diluent into the flash-filtration-bottle outer tube 2002. After dispensing is completed, the first tube-clamping mechanism 31 clamps the flash-filtration-bottle inner tube 2001 from the flash-filtration-bottle inner-tube tray and transfers the flash-filtration-bottle inner tube 2001 above the flash-filtration-bottle outer tube 2002, with the flash-filter-bottle inner tube 2001 partially extending into the flash-filter-bottle outer tube 2002. Thereafter, the first lifting mechanism 14 drives the filtration-press plate 21 to press down and abut against the flash-filtration-bottle inner tube 2001 to perform the filtration-pressing action. After the filtration-pressing is completed, the filtration-press plate 21 moves up, and the flash-filtration-bottle transfer assembly 50 drives the flash-filtration-bottle outer-tube tray and the flash-filtration-bottle inner-tube tray to move to the liquid-transfer workstation, thereby completing a single batch experiment process.

The experimental platform 1000 can repeat the above process until the sampling and flash-filtration of all sample liquids in the same batch are completed.

In the description of embodiments of the present disclosure, it may be noted that orientation or positional relations indicated by terms such as “center”, “on”, “under”, “left”, “right”, “vertical”, “horizontal”, “in”, “out”, and the like are orientation or positional relations based on the accompanying drawings, only for facilitating description of the present disclosure and simplifying the description, rather than explicitly or implicitly indicating the referred apparatuses or elements must be in a particular orientation or constructed or operated in the particular orientation, and therefore they may not be construed as limiting the present disclosure.

The above embodiments are only one of preferable embodiments of the present disclosure, and cannot be used to limit the scope of the claims of the present disclosure. Those of ordinary skill in the art can understand all or a part of the process to realize the above embodiments of the present disclosure, and the equivalent changes made in accordance with the claims of the present disclosure still belong to the scope of the present disclosure.

What is claimed is:

1. A flash-filtration apparatus, comprising:
a support assembly;
a filtration-press assembly comprising a filtration-press plate, wherein the filtration-press plate is slidably connected to the support assembly and movable in a first direction; and
a first clamping assembly comprising a first tube-clamping mechanism, wherein the first tube-clamping mechanism is slidably connected to the support assembly and movable in a second direction, and the second direction intersects the first direction;
wherein the first tube-clamping mechanism is configured to clamp and move a flash-filtration-bottle inner tube, and place part of the flash-filtration-bottle inner tube into a flash-filtration-bottle outer tube, and the filtration-press plate is configured to press the flash-filtration-bottle inner tube into the flash-filtration-bottle outer tube.

2. The flash-filtration apparatus of claim 1, wherein the support assembly comprises a support post and a movable plate, the support post extends in the first direction, and the movable plate is slidably connected to the support post and movable in the first direction;
the filtration-press plate is slidably connected to the movable plate and also movable in the second direction; and the first tube-clamping mechanism is slidably connected to the movable plate and movable in the second direction, and the first tube-clamping mechanism is also movable relative to the filtration-press plate in the first direction; and
the support assembly further comprises a top plate and a first lifting mechanism, the top plate is fixedly connected to the support post, the first lifting mechanism is disposed on the top plate and connected to the movable plate, and the first lifting mechanism is configured to drive the movable plate to move in the first direction.

3. The flash-filtration apparatus of claim 2, wherein the filtration-press assembly further comprises a first translation mechanism and a first sliding table, the first translation mechanism is disposed on the movable plate, the first sliding table is slidably connected to the movable plate in the second direction, the filtration-press plate is connected to the first sliding table, and the first translation mechanism is connected to the first sliding table and is configured to drive the first sliding table to move in the second direction; and
the first clamping assembly further comprises a guide shaft, a second sliding table, and a second lifting mechanism, the guide shaft extends in the first direction, the guide shaft has one end connected to the first sliding table and another end connected to the filtration-press plate, the second sliding table is slidably connected to the guide shaft, the first tube-clamping mechanism is connected to the second sliding table, the second lifting mechanism is disposed on the first sliding table and connected to the second sliding table, and the second lifting mechanism is configured to drive the second sliding table to move in the first direction.

4. The flash-filtration apparatus of claim 1, wherein the support assembly comprises a support frame and a first lifting mechanism disposed on the support frame, the first lifting mechanism is connected to the filtration-press plate, and the first lifting mechanism is configured to drive the filtration-press plate to move in the first direction; and
the first tube-clamping mechanism is slidably connected to the filtration-press plate and is movable in the second direction; and the filtration-press assembly further comprises a first translation mechanism, the first translation mechanism is disposed on the filtration-press plate, and the first translation mechanism is connected to the first tube-clamping mechanism and is configured to drive the first tube-clamping mechanism to move in the second direction.

5. The flash-filtration apparatus of claim 2, wherein the filtration-press assembly further comprises a pressure sensor; the pressure sensor is disposed on the movable plate and is configured to abut against the first lifting mechanism to obtain pressure data, or the pressure sensor is disposed on the first lifting mechanism and is configured to abut against the movable plate to obtain pressure data; and the pressure data is used to characterize a moving distance of the filtration-press plate in the first direction;
the first lifting mechanism comprises a first lifting driving member and a first transmission rod, the first lifting driving member is disposed on the top plate, the first transmission rod is connected to the movable plate, and the first lifting driving member is in transmission fit with the first transmission rod to drive the movable plate to move in the first direction; and
the first lifting mechanism further comprises a first floating joint and a second floating joint, the first floating joint is connected to the first transmission rod, the second floating joint is fixedly connected to the movable plate and movably connected to the first transmission rod, and the pressure sensor is disposed on the first floating joint or the second floating joint and is located between the first floating joint and the second floating joint.

6. The flash-filtration apparatus of claim 3, wherein the first tube-clamping mechanism comprises a first clamping driving member, a first clamping portion, and a second clamping portion, the first clamping driving member is disposed on the second sliding table, at least one of the first clamping portion or the second clamping portion is connected to the first clamping driving member, and the first clamping driving member is configured for relative movement between the first clamping portion and the second clamping portion to clamp the flash-filtration-bottle inner tube; and
the first clamping portion comprises a first mounting plate and a plurality of groups of first fingers, the plurality of groups of first fingers are arranged at intervals on the first mounting plate, and each group of the plurality of groups of first fingers comprises at least one first finger; the second clamping portion comprises a second mounting plate and a plurality of groups of second fingers, the plurality of groups of second fingers are arranged at intervals on the second mounting plate, and each group of the plurality of groups of second fingers comprises at least one second finger; and the plurality of groups of first fingers and the plurality of groups of second fingers are arranged in a one-to-one correspondence, and each group of the plurality of groups of first fingers and one corresponding group of the plurality of groups of second fingers are movable relative to each other, to clamp the flash-filtration-bottle inner tube.

7. The flash-filtration apparatus of claim 1, wherein the flash-filtration apparatus further comprises a liquid-dispensing assembly, the liquid-dispensing assembly is connected to the filtration-press assembly and is configured to dispense sample liquid or diluent to the flash-filtration-bottle outer tube; the liquid-dispensing assembly comprises a liquid-dispensing needle and a liquid-dispensing pump, the liquid-dispensing needle is connected to the filtration-press plate, and the liquid-dispensing pump is in communication with the liquid-dispensing needle and is configured to output the sample liquid or the diluent to the liquid-dispensing needle; and
the liquid-dispensing assembly further comprises a cleaning mechanism, the cleaning mechanism comprises a cleaning tank and a cleaning pump, the cleaning pump is in communication with the cleaning tank, the cleaning tank is configured for accommodation of at least part of the liquid-dispensing needle and collection of waste cleaning liquid, and the cleaning pump is configured to discharge the waste cleaning liquid from the cleaning tank.

8. The flash-filtration apparatus of claim 1, wherein the flash-filtration apparatus further comprises a flash-filtration-bottle transfer assembly, the flash-filtration-bottle transfer assembly comprises a flash-filtration-bottle tray placement seat, and the flash-filtration-bottle tray placement seat is configured for placement of the flash-filtration-bottle inner tube and/or the flash-filtration-bottle outer tube; and
the flash-filtration-bottle transfer assembly further comprises a first moving mechanism, the first moving mechanism is connected to the flash-filtration-bottle tray placement seat and is configured to drive the flash-filtration-bottle tray placement seat to move in the second direction and/or a third direction, and the third direction intersects both the first direction and the second direction.

9. The flash-filtration apparatus of claim 8, wherein the flash-filtration-bottle tray placement seat comprises a first tray-placement-seat and a second tray-placement-seat, one of the first tray-placement-seat and the second tray-placement-seat is configured for placement of the flash-filtration-bottle inner tube, and another of the first tray-placement-seat and the second tray-placement-seat is configured for placement of the flash-filtration-bottle outer tube; wherein
the first tray-placement-seat and the second tray-placement-seat are arranged in the second direction, the first tray-placement-seat is spaced apart from the second tray-placement-seat in the first direction, and the first tray-placement-seat is closer to the filtration-press plate than the second tray-placement-seat in the first direction; or
the filtration-press plate is spaced apart from the first tube-clamping mechanism in the third direction, and the first tray-placement-seat and the second tray-placement-seat are arranged in the third direction.

10. The flash-filtration apparatus of claim 8, wherein the flash-filtration apparatus further comprises a baffle plate, the baffle plate is disposed on the support assembly and is spaced apart from the flash-filtration-bottle tray placement seat in the first direction, the baffle plate defines a through hole in the first direction, an aperture of the through hole is configured to be less than an outer diameter of the flash-filtration-bottle inner tube, and the first moving mechanism is configured to drive the flash-filtration-bottle tray placement seat to move to the baffle plate.

11. An experimental platform, comprising a base and a flash-filtration apparatus, wherein the flash-filtration apparatus comprises:
a support assembly mounted on the base;
a filtration-press assembly comprising a filtration-press plate, wherein the filtration-press plate is slidably connected to the support assembly and movable in a first direction; and
a first clamping assembly comprising a first tube-clamping mechanism, wherein the first tube-clamping mechanism is slidably connected to the support assembly and movable in a second direction, and the second direction intersects the first direction;
wherein the first tube-clamping mechanism is configured to clamp and move a flash-filtration-bottle inner tube, and place part of the flash-filtration-bottle inner tube into a flash-filtration-bottle outer tube, and the filtration-press plate is configured to press the flash-filtration-bottle inner tube into the flash-filtration-bottle outer tube.

12. The experimental platform of claim 11, wherein the experimental platform further comprises a sampling apparatus, and the sampling apparatus comprises a pipetting assembly; and
the pipetting assembly is configured to transfer sample liquid or diluent into the flash-filtration-bottle outer tube, or the pipetting assembly is configured to extract filtrate from the flash-filtration-bottle inner tube after filtration.

13. The experimental platform of claim 12, wherein the support assembly comprises a support post, a top plate, and a side plate, the support post extends in the first direction, the top plate is fixedly connected to the support post, and the side plate is fixedly connected to the top plate and/or the support post; the pipetting assembly comprises a pipette-tip mounting seat and a pipetting pump, the pipette-tip mounting seat is configured for mounting of a pipette tip, and the pipetting pump is in communication with the pipette tip and is configured to transfer the sample liquid or the diluent into the flash-filtration-bottle outer tube through the pipette tip; and the sampling apparatus further comprises a second translation mechanism and a third sliding table, the second translation mechanism is disposed on the side plate, the third sliding table is slidably connected to the side plate in the second direction or a third direction, the second translation mechanism is connected to the third sliding table and is configured to drive the third sliding table to move relative to the side plate, and the third direction intersects both the first direction and the second direction;
the pipetting assembly is slidably connected to the third sliding table and is movable relative to the third sliding table in the first direction; and
the pipetting assembly further comprises a fourth sliding table and a third lifting mechanism, the third lifting mechanism is disposed on the third sliding table, the fourth sliding table is slidably connected to the third sliding table in the first direction, the pipette-tip mounting seat is connected to the fourth sliding table, and the third lifting mechanism is connected to the fourth sliding table and is configured to drive the fourth sliding table to move in the first direction.

14. The experimental platform of claim 13, wherein the third sliding table is slidably connected to the side plate in the second direction; the pipetting assembly further comprises a first mounting platform and a spacing-adjusting mechanism, the pipette-tip mounting seat is implemented as a plurality of pipette-tip mounting seats, the first mounting platform is fixedly connected to the fourth sliding table, and the plurality of pipette-tip mounting seats are all slidably connected to the first mounting platform and are movable in the third direction; and the spacing-adjusting mechanism is disposed on the first mounting platform and is connected to the plurality of pipette-tip mounting seats, and the spacing-adjusting mechanism is configured to drive the plurality of pipette-tip mounting seats to move in the third direction to adjust a distance between any adjacent two of the plurality of pipette-tip mounting seats; wherein
the spacing-adjusting mechanism comprises a spacing-adjusting driving member and a spacing-adjusting plate, the spacing-adjusting driving member is disposed on the first mounting platform, the spacing-adjusting plate is in transmission connection with the spacing-adjusting driving member, the plurality of pipette-tip mounting seats are all movably connected to the spacing-adjusting plate, and the spacing-adjusting driving member is configured to drive the spacing-adjusting plate to move in the first direction to drive the plurality of pipette-tip mounting seats to move in the third direction; and/or
the pipetting assembly further comprises a pressing plate, a pressing mechanism and a plurality of separating members, the plurality of separating members are disposed on the pressing plate and are slidably connected to the pressing plate, the plurality of separating members and the plurality of pipette-tip mounting seats are arranged in a one-to-one correspondence and are synchronously movable in the third direction, and the plurality of separating members are also movable relative to the plurality of pipette-tip mounting seats in the first direction; and the pressing mechanism is disposed on the first mounting platform and is connected to the pressing plate, and the pressing mechanism is configured to drive the plurality of separating members to move in the first direction to separate the pipette tip from a corresponding pipette-tip mounting seat of the plurality of pipette-tip mounting seats.

15. The experimental platform of claim 13, wherein the sampling apparatus further comprises a second clamping assembly, the second clamping assembly is connected to the fourth sliding table and is configured to clamp and move a test tube, and the test tube is configured for containing the sample liquid or the diluent; and
the second clamping assembly comprises a second mounting platform, a fourth lifting mechanism, and a second tube-clamping mechanism, the second mounting platform is fixedly connected to the fourth sliding table, the fourth lifting mechanism is disposed on the second mounting platform and is connected to the second tube-clamping mechanism, the fourth lifting mechanism is configured to drive the second tube-clamping mechanism to move relative to the second mounting platform in the first direction, and the second tube-clamping mechanism is configured to clamp the test tube.

16. The experimental platform of claim 15, wherein the second tube-clamping mechanism comprises a second clamping driving member, a third clamping portion, and a fourth clamping portion, the second clamping driving member is connected to the fourth lifting mechanism, at least one of the third clamping portion or the fourth clamping portion is connected to the second clamping driving member, and the second clamping driving member is configured to drive the third clamping portion and the fourth clamping portion to move relative to each other to clamp the test tube; and/or
the second clamping assembly further comprises a buffering mechanism and a third mounting platform, the third mounting platform is connected to the fourth lifting mechanism, and the buffering mechanism is disposed between the third mounting platform and the second tube-clamping mechanism and is configured for movement of the second tube-clamping mechanism relative to the third mounting platform in the first direction; and/or
the sampling apparatus further comprises a test-tube rack assembly, the test-tube rack assembly comprises a test-tube rack placement seat and a test-tube mounting frame, the test-tube mounting frame is mounted on the base, the test-tube rack placement seat is disposed on the test-tube mounting frame, and the test-tube rack placement seat is configured for placement of the test tube.

17. The experimental platform of claim 16, wherein the third clamping portion comprises a third mounting plate and a plurality of groups of third fingers, the plurality of groups of third fingers are arranged at intervals on the third mounting plate, and each group of the plurality of groups of third fingers comprises at least one third finger; the fourth clamping portion comprises a fourth mounting plate and a plurality of groups of fourth fingers, the plurality of groups of fourth fingers are arranged at intervals on the fourth mounting plate, and each group of the plurality of groups of fourth fingers comprises at least one fourth finger; the plurality of groups of third fingers and the plurality of groups of fourth fingers are arranged in a one-to-one correspondence, and are movable relative to each other to clamp the test tube; the third clamping portion further comprises a mounting shaft, limit rings, and pre-tightening springs, the mounting shaft is connected to the third mounting plate and extends in a moving direction of the third clamping portion, each group of the plurality of groups of third fingers is slidably connected to the mounting shaft and is provided with a limit ring at one side of the group of the plurality of groups of third fingers away from a corresponding fourth finger, the limit rings are sleeved on the mounting shaft and fixedly connected to the mounting shaft, the group of the plurality of groups of third fingers and a corresponding limit ring are provided with a pre-tightening spring therebetween, and the pre-tightening spring has one end elastically abutting against the corresponding limit ring and another end elastically abutting against a corresponding third finger of the group of the plurality of groups of third fingers; and/or
the second tube-clamping mechanism further comprises a third transmission member and a fourth transmission member, the second clamping driving member is connected to each of the third transmission member and the fourth transmission member, the third transmission member is connected to the third clamping portion, the fourth transmission member is connected to the fourth clamping portion, and the second clamping driving member is configured to drive the third transmission member and the fourth transmission member to move in opposite directions.

18. The experimental platform of claim 12, wherein the sampling apparatus further comprises a pipette-tip tray assembly, the pipette-tip tray assembly comprises a pipette-tip tray placement seat and a second moving mechanism, the pipette-tip tray placement seat is slidably connected to the base and movable in the second direction and/or a third direction, the second moving mechanism is disposed on the base and connected to the pipette-tip tray placement seat, the second moving mechanism is configured to drive the pipette-tip tray placement seat to move relative to the base, the pipette-tip tray placement seat is configured for placement of a pipette tip, and the third direction intersects both the first direction and the second direction; and
the pipette-tip tray assembly further comprises a pipette-tip mounting frame, the pipette-tip mounting frame is connected to the second moving mechanism, the pipette-tip tray placement seat is disposed on the pipette-tip mounting frame, the pipette-tip mounting frame and the base define an avoidance space therebetween, and the avoidance space allows for accommodation of at least part of the flash-filtration-bottle tray placement seat.

19. The experimental platform of claim 16, wherein the sampling apparatus further comprises a third clamping assembly, the third clamping assembly is disposed close to the test-tube rack assembly, and the third clamping assembly is configured to open or close a cap of the test tube;
the third clamping assembly comprises a third tube-clamping mechanism, the third tube-clamping mechanism is configured to clamp a tube body of the test tube and rotate around a first axis, and the third tube-clamping mechanism is configured to cooperate with the second tube-clamping mechanism to open or close the test tube; and
the third tube-clamping mechanism comprises a third clamping driving member, a finger mounting seat, and a plurality of fifth fingers, the third clamping driving member is disposed on the finger mounting seat, the plurality of fifth fingers are arranged at intervals in a circumferential direction of the finger mounting seat and slidably connected to the finger mounting seat, and the third clamping driving member is connected to the plurality of fifth fingers and is configured to drive the plurality of fifth fingers to move in a radial direction of the finger mounting seat to clamp the tube body of the test tube.

20. The experimental platform of claim 19, wherein the third tube-clamping mechanism is implemented as a plurality of third tube-clamping mechanisms, the third clamping assembly further comprises a rotary driving member, a first gear, and second gears, the rotary driving member is connected to the first gear, each of the plurality of third tube-clamping mechanisms is connected to and coaxial with one of the second gears, the first gear is engaged with one of the second gears, adjacent two of the second gears are engaged with each other, and the rotary driving member is configured to drive the first gear to rotate to drive the plurality of third tube-clamping mechanisms to synchronously rotate around the first axis through the second gears; and
the test-tube mounting frame is provided with a magnet mounting plate at one side of the test-tube mounting frame close to the third clamping assembly, the magnet mounting plate extends in an arrangement direction of the plurality of third tube-clamping mechanisms, the magnet mounting plate is provided with a plurality of magnets arranged at intervals, and the plurality of magnets and the plurality of third tube-clamping mechanisms are arranged in a one-to-one correspondence.
